(19) United States
(12) Patent Application Publication
(10) Pub. No.: US 2008/0182637 A1
(43) Pub. Date: Jul. 31, 2008

(54) GAME APPARATUS FOR ACCEPTING PARTICIPATION OF PLURAL PLAYERS

(75) Inventor: Kazumasa YOSHIZAWA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Corp., Tokyo (JP)

(21) Appl. No.: 12/017,741

(22) Filed: Jan. 22, 2008

(30) Foreign Application Priority Data
Jan. 23, 2007 (JP) 2007-013014

(51) Int. Cl. A63F 13/00

(52) U.S. Cl. 463/16

(57) ABSTRACT

A game apparatus includes a plurality of terminals, a control unit, a horse race gaming machine, and a roulette gaming machine. Each of the terminals receives a bet on a horse race game and a bet on a roulette game. The control unit allows a first betting period for receiving the bet on the horse race game and a second betting period for receiving the bet on the roulette game to overlap each other. The horse race gaming machine is provided commonly to the plurality of terminals and executes the horse race game. The roulette gaming machine is provided commonly to the plurality of terminals and executes the roulette game.

### CROSS REFERENCE TO RELATED APPLICATION

This application claims benefit of priority under 35 U.S.C. §119 to Japanese Patent Application No. 2007-013014, filed on Jan. 23, 2007, the entire contents of which are incorporated by reference herein.

### BACKGROUND OF THE INVENTION

1. Field of the Invention

The present invention relates to a game apparatus that executes a game in which plural players are capable of participating.

2. Description of the Related Art

For example, in a game such as a roulette game in which plural players are capable of participating, a person called a dealer, who assists a progress of the game, is distributed, and the game is progressed.

US Patent Application Publication No. 2005/0282623 proposes a game apparatus adapted to execute, without the dealer, the game in which the plural players are capable of participating. However, in this conventional game apparatus, it has been difficult for each of the players to participate in a plurality of the games simultaneously.

### SUMMARY OF THE INVENTION

It is an object of the present invention to provide a game apparatus with a new entertainment factor.

In order to achieve the above-described object, the present invention provides a game apparatus which includes: a plurality of terminals, each of which receives a bet on a first game and a bet on a second game; a bet control unit that allows a first betting period for receiving the bet on the first game and a second betting period for receiving the bet on the second game to overlap each other; a first control unit that is provided commonly to the plurality of terminals and executes the first game; and a second control unit that is provided commonly to the plurality of terminals and executes the second game.

In accordance with the present invention, a control is made so that such a reception period for the bet on the first game and such a reception period for the bet on the second game can overlap each other in each of the terminals. In such a way, a player is given an opportunity to simultaneously participate in both of the first game and the second game.

In order to achieve the above-described object, the present invention provides a game apparatus which includes: a plurality of terminals, each of which includes a first input unit that receives a bet on a first game and a second input unit that receives a bet on a second game; a bet control unit that allows a first betting period for receiving the bet on the first game and a second betting period for receiving the bet on the second game to overlap each other; a first control unit that is provided commonly to the plurality of terminals and executes the first game; and a second control unit that is provided commonly to the plurality of terminals and executes the second game.

In accordance with the present invention, the control is made so that the reception period for the bet on the first game and the reception period for the bet on the second game can overlap each other in each of the terminals. In addition, the bet on the first game is received by the first input unit, and the bet on the second game is received by the second input unit. In such a way, each player is given the opportunity to simultaneously participate in both of the first game and the second game.

In order to achieve the above-described object, the present invention provides a game apparatus which includes: a plurality of terminals, each of which includes an input unit that receives a bet on a first game and a bet on a second game; a switching control unit that allows the input unit to receive an input of the bet on the first game or to receive an input of the bet on the second game; a bet control unit that allows a first betting period for receiving the bet on the first game and a second betting period for receiving the bet on the second game to overlap each other; a first control unit that is provided commonly to the plurality of terminals and executes the first game; and a second control unit that is provided commonly to the plurality of terminals and executes the second game.

In accordance with the present invention, the control is made so that the reception period for the bet on the first game and the reception period for the bet on the second game can overlap each other in each of the terminals. In addition, the input unit of each of the terminals is switched to receive the input of the bet on the first game or to receive the input of the bet on the second game. In such a way, the input unit is switched during the betting period, whereby each player can simultaneously participate in both of the first game and the second game.

In a preferred embodiment of the present invention, each of the terminals visually displays elapse of time during a first reception period and a second reception period.

In accordance with this embodiment, the player is notified of a remaining time in the betting period.

In a preferred embodiment of the present invention, the bet control unit pre-stores the bet on the first game and the bet on the second game and receives the stored bets during the first and second betting periods.

In accordance with this embodiment, the reception of the bets is always executed regardless of a progress of the first game and the second game. In such reception processing for the bets, the bet on the first game is received, and the bet on the second game is received. In such a way, each player is given the opportunity to simultaneously participate in both of the first and second games.

### BRIEF DESCRIPTION OF THE DRAWINGS

FIG. 1 is a schematic view showing a game apparatus according to a first embodiment of the present invention.

FIG. 2 is a perspective view showing an exterior appearance of the game apparatus according to the first embodiment of the present invention.

FIG. 3 is a block diagram showing a configuration of the game apparatus according to the first embodiment of the present invention.

FIG. 4 is a schematic diagram showing data stored in a ROM of a control unit of FIG. 3.

FIG. 5 is a schematic diagram showing data stored in a RAM of the control unit of FIG. 3.

FIG. 6 is a block diagram showing a configuration of a horse race gaming machine of FIG. 3.

FIG. 7 is a cross-sectional view showing a configuration of a running body of FIG. 6.

FIG. 8 is a block diagram showing a configuration of a lower cabinet of the running body of FIG. 7.

FIG. 9 is a block diagram showing a configuration of a roulette gaming machine of FIG. 3.

FIG. 10 is a plan view showing an exterior appearance of the roulette gaming machine of FIG. 9.

FIG. 11 is a block diagram showing a configuration of a terminal of FIG. 3.

FIG. 12 is a schematic diagram showing a storage area of a RAM of a terminal of FIG. 11.

FIG. 13 is a front view showing a display screen of an image display device of the terminal of FIG. 11.

FIG. 14 is a front view showing a bet screen for a horse race game, which is displayed on a first window of the display screen of FIG. 13.

FIG. 15 is a front view showing a bet screen for a roulette game, which is displayed on a second window of the display screen of FIG. 13.

FIG. 16 is a flowchart showing a processing procedure for receiving a bet, which is executed in the terminal of FIG. 11.

FIG. 17 is a flowchart showing a processing procedure related to a control of games, which is executed in the control unit of FIG. 3.

FIG. 18 is a front view showing a bet screen for a horse race game, which is displayed on a terminal of a game apparatus according to a second embodiment of the present invention.

FIG. 19 is a front view showing a bet screen for a roulette game, which is displayed on the terminal of the game apparatus according to the second embodiment of the present invention.

FIG. 20 is a flowchart showing a processing procedure for receiving a bet, which is executed in the terminal of the game apparatus according to the second embodiment of the present invention.

FIG. 21 is a schematic diagram showing a storage area of a RAM of the terminal of the game apparatus according to the second embodiment of the present invention.

FIG. 22 is a front view showing a display screen of a terminal of a game apparatus according to a third embodiment of the present invention.

FIG. 23 is a flowchart showing bet receiving processing executed in the terminal of the game apparatus according to the third embodiment of the present invention.

FIG. 24 is a schematic view showing bet information previously inputted to and stored in the game apparatus according to the third embodiment of the present invention.

FIG. 25 is a flowchart showing a processing procedure for receiving a bet, which is executed in the terminal of the game apparatus according to the third embodiment of the present invention.

FIG. 26 is a flowchart showing bet receiving processing executed in a terminal of a game apparatus according to another embodiment of the present invention.

### DETAILED DESCRIPTION OF THE PREFERRED EMBODIMENTS

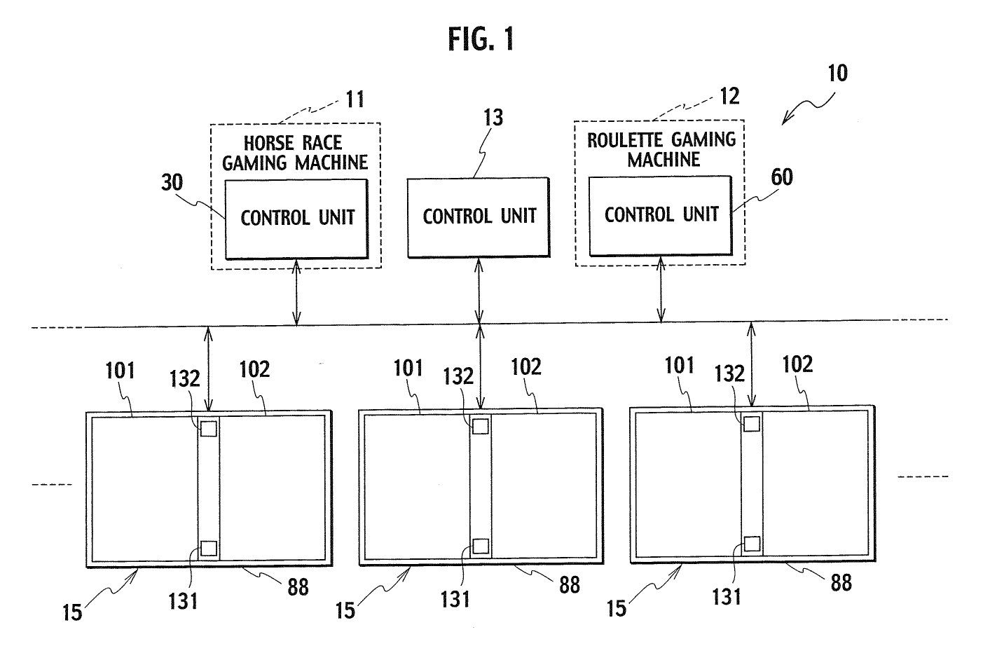

A description will be made below in detail of embodiments of the present invention with reference to FIGS. 1 to 26. In the following description made with reference to the drawings, the same reference numerals are assigned to the same portions, and a duplicate description is omitted. The drawings are schematic, and dimensions and the like of the respective portions are different from actual ones.

### First Embodiment

As shown in FIG. 1, a game apparatus 10 according to a first embodiment includes: a plurality of terminals 15, each of which receives a bet on a first game and a bet on a second game; a control unit 13 (a bet control unit) that allows a first betting period for receiving the bet on the first game and a second betting period for receiving the bet on the second game to overlap each other; control units 13 and 30 (a first game control unit) which are provided commonly to the plurality of terminals 15, and execute the first game; and control units 13 and 60 (a second game control unit) which are provided commonly to the plurality of terminals 15, and execute the second game. In this embodiment, a description will be made of the case where the control unit 13 provided commonly to the respective terminals 15 is used as the bet control unit, and by a control of the control unit 13, the first betting period for the first game and the second betting period for the second game are overlapped with each other. However, the present invention is not limited to the control in this case, and such bet control units may be provided in the respective terminals, and in each of the terminals, a control may be performed so as to allow the first betting period and the second betting period to overlap each other. In this embodiment, a description will be made of the case of executing the first and second games in the following manner. Specifically, these games are executed by being progressed by the control unit 30 of a first gaming machine (a horse race gaming machine 11) and the control unit 60 of a second gaming machine (a roulette gaming machine 12) under the control of the control unit 13 provided commonly to the respective terminals 15. In this case, the first game control unit is composed of the control units 13 and 30, and the second game control unit is composed of the control units 13 and 60. However, the present invention is not limited to this, and the control unit 13 may be adapted to directly control the horse race gaming machine 11 and the roulette gaming machine 12 to progress the respective games. In this case, the control unit 13 composes the first game control unit and the second game control unit.

An image display device 88 is provided on each of the terminals 15. A first window 101 and a second window 102 are provided on the image display device 88. On the first window 101, an image for an input operation for making a bet on a horse race game is displayed, and on the second window 102, an image for an input operation for making a bet on a roulette game is displayed. Touch panels are provided on surfaces of display screens of the respective windows 101 and 102. In such a way, the first window 101 composes an input operation unit for making the bet on the horse race game, and the second window 102 composes an input operation unit for making the bet on the roulette game.

A control unit 80 of each of the terminals 15 receives an operation result, which is obtained from the touch panel provided on the first window 101, as an input of the bet on the horse race game, and receives an operation result, which is obtained from the touch panel provided on the second window 102, as an input of the bet on the roulette game.

A control is performed so that a period for receiving the bet on the horse race game and a period for receiving the bet on the roulette game can overlap each other. In such a way, a player can participate in both of the first game and the second game simultaneously by operating the first window 101 and the second window 102 during such a period in which both of the above-described periods overlap each other.

A betting time display region 132 is provided between the first window 101 and the second window 102. On the betting time display region 132, a time course during such a betting period for receiving the bet is displayed. In the case of this embodiment, a remaining time in the betting period is displayed as the time course.

A number-of-credits display region 131 is provided between the first window 101 and the second window 102. On the number-of-credits display region 131, the number of credits owned by the player who operates the terminal 15 is displayed.

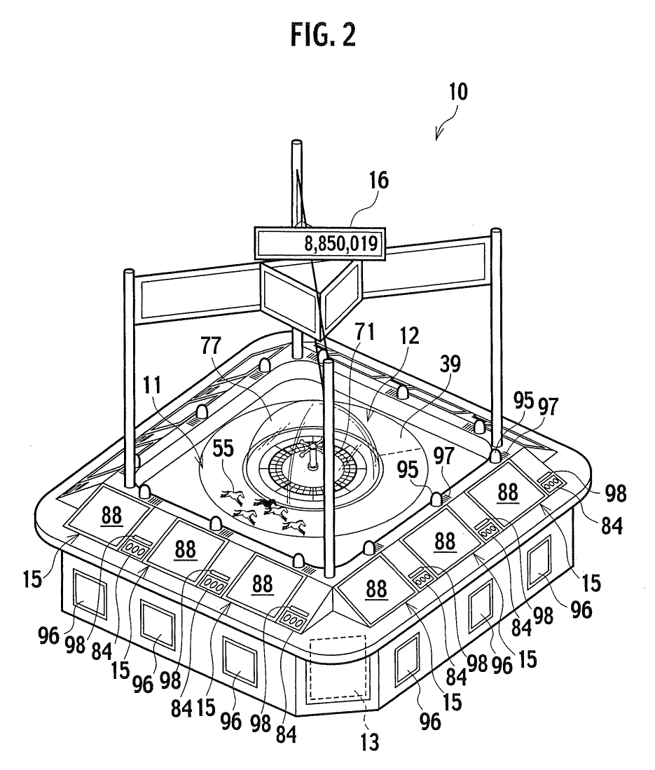

FIG. 2 shows an exterior appearance of the game apparatus 10. The game apparatus 10 includes: the plurality of terminals 15 for making bets on the horse race game (the first game) and the roulette game (the second game); the horse race gaming machine 11 that executes the horse race game; and the roulette gaming machine 12 that executes the roulette game. The terminals 15, the horse race gaming machine 11 and the roulette gaming machine 12 are controlled by the control unit 13.

Each of the terminals 15 includes: an operation unit (a switch unit 84) for allowing the player to make a bet; and a display unit (the image display device 88) for displaying information regarding the games, such as progress situations of the hose race game in the horse race gaming machine 11 and of the roulette game in the roulette gaming machine 12.

In the horse race gaming machine 11, on an upper surface of a gaming machine body thereof, a track 39 for running a plurality of model horses 55 thereon is provided. Each of the terminals 15 receives a bet input on the horse race game executed in the horse race gaming machine 11, in which the bet input is made by the player.

In the roulette gaming machine 12, a roulette wheel 71 is rotatably provided. A plurality of pockets are provided on an upper surface of the roulette wheel 71. In the roulette game, a ball is launched onto the roulette wheel 71 that is rotating, and the ball then enters any of the plurality of pockets. Each of the terminals 15 receives a bet input on the roulette game executed in the roulette gaming machine 12, in which the bet input is made by the player.

The control unit 13 individually controls the horse race gaming machine 11 and the roulette gaming machine 12. In such a way, the respective games progress individually. Moreover, the control unit 13 stores results of making the bets in the respective terminals 15, and calculates payouts to the respective terminals 15 based on results of the horse race game and the roulette game and on the results of making the bets in the respective terminals 15.

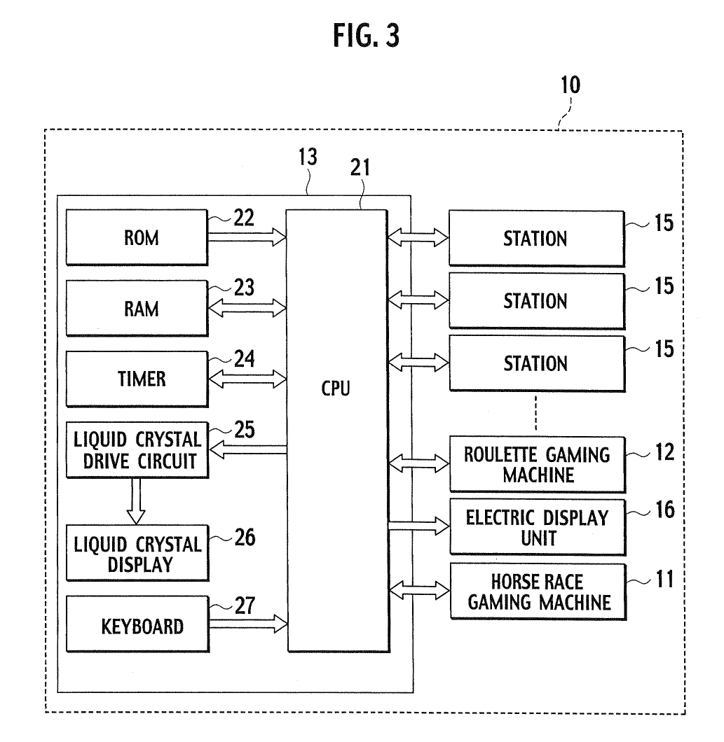

As shown in FIG. 3, the control unit 13 of the game apparatus 10 includes a central processing unit (CPU) 21, a ROM 22, a RAM 23, a timer 24, a liquid crystal drive circuit 25, a liquid crystal display 26, and a keyboard 27. The CPU 21 controls the entirety of the control unit 13. The liquid crystal display 26 is connected to the CPU 21 through the liquid crystal drive circuit 25.

The CPU 21 performs a variety of processing based on input signals supplied from the respective terminals 15 and on data and programs, which are stored in the ROM 22 and the RAM 23. Then, the CPU 21 transmits control data to the terminals 15 based on results of the respective pieces of the processing. In such a way, the CPU 21 controls the respective terminals 15. Moreover, the CPU 21 transmits control data to the horse race gaming machine 11, and controls the running of the model horses 55, and in addition, transmits control data to the roulette gaming machine 12, and controls the launching of the ball and the rotation of the roulette wheel 71.

The ROM 22 is composed, for example, of a semiconductor memory or the like. The ROM 22 stores: the respective programs for realizing basic functions of the horse race gaming machine 11 and the roulette gaming machine 12; the respective programs for issuing a notice on timing of maintenance, setting contents of the notice, and so on; payout multiplication factors (the number of credit payouts per medal with respect to a winning); programs for controlling the respective terminals 15; and the like.

The RAM 23 stores: information on the bet of the medals, which is supplied from each of the terminals 15; winning numbers in the horse race game and the roulette game; information on an award (the number of paid out credits) generated in response to a winning result; data regarding the number of credits in each of the terminals 15 (the number of credits owned by each of the players) and regarding results of the processing executed by the CPU 21; and the like. When the medals are inserted into each of the terminals 15, the control unit 13 receives, from the terminal 15, information indicating the number of such inserted medals, and increases the number of credits in the terminal 15 concerned, which is stored in the RAM 23, by the number of inserted medals. Meanwhile, upon receiving such bet information from each of the terminals 15, the control unit 13 stores the bet information concerned in the RAM 23 in association with the terminal 15 as a transmission source thereof, and reduces the number of credits in the terminal 15 concerned by the number of bets, which is indicated in the bet information. The bet information is information indicating contents of the bets made by each of the terminals on the horse race game and the roulette game. In the horse race game, for example, the bet information is information in which a combination of a first place and a second place and the number of bet medals are associated with each other. In the roulette game, for example, the bet information is information in which a number pocket number and the number of bets are associated with each other. In the RAM 23, these pieces of bet information are stored in association with information indicating the terminal 15 in which the bets concerned are made. Moreover, upon receiving results of the games from the horse race gaming machine 11 and the roulette gaming machine 12, the control unit 13 stores the results (the winning numbers) of the games in the RAM 23. Then, the control unit 13 calculates the payouts to the respective terminals 15 based on the results of the games and the bet information obtained from the respective terminals 15, and stores the payouts in the RAM 23. Then, based on the payouts, the control unit 13 updates the number of credits owned by each of the terminals 15, in which the number is stored in the RAM 23. Meanwhile, upon receiving a request for paying back the credits from each of the terminals 15, the control unit 13 rewrites, to “0”, the number of credits, which is stored in the RAM 23 in association with each of the terminals 15.

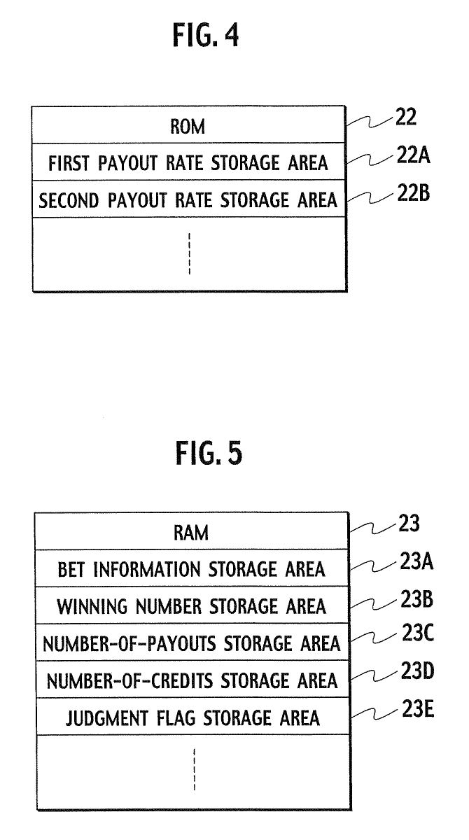

FIG. 4 is a schematic diagram showing a storage region of the ROM 22 of the control unit 13 according to this embodiment. As shown in FIG. 4, a first payout rate storage area 22A and a second payout rate storage area 22B are provided in the ROM 22.

The first payout rate storage area 22A stores combinations of payout multiplication factors related to the horse race game and control data for the respective horses, which is associated with the payout multiplication factors, together with identifiers for specifying these combinations. The second payout rate storage area 22B stores payout multiplication factors related to the roulette game. The payout multiplication factors in the roulette game differ depending on types (“straight bet”, “corner bet”, “split bet”, and the like) of betting methods. For example, the plurality of multiplication factors, such as “×2” to “×36”, are preset so as to correspond to these betting methods. These multiplication factors are stored in the second payout rate storage area 22B in association with the betting methods.

FIG. 5 is a schematic diagram showing a storage region of the RAM 23 of the control unit 13 according to this embodiment. As shown in FIG. 5, the RAM 23 includes a bet information storage area 23A, a winning number storage area 23B, a number-of-payouts storage area 23C, a number-of-credits storage area 23D, and a judgment flag storage area 23E. In the bet information storage area 23A, the bet information received from each of the terminals 15 is stored. Specifically, the contents of the bets for each of the terminals 15, which are made on the horse race game and the roulette game, are stored in the bet information storage area 23A. In the winning number storage area 23B, place orders in the horse race game are stored by the predetermined number of times that the horse race game was executed in the past, and in addition, the winning numbers in the roulette game are stored by the predetermined number of times that the roulette game was executed in the past. In the number-of-payouts storage area 23C, the payouts (the winning results) to the respective terminals 15 in the horse race game and the roulette game, each of which is executed one time, are stored by the predetermined number of times that the horse race game and the roulette game were executed in the past. In the number-of-credits storage area 23D, the number of credits owned by each of the terminals 15 (each of the players) is stored. In the judgment flag storage area 23E, flags, each of which represents whether or not a judgment of the winning for each of the horse race game and the roulette game is ended, are stored.

Moreover, in the control unit 13 (FIG. 3), a timer 24 that measures a time is connected to the CPU 21. Time information of the timer 24 is transmitted to the CPU 21. Based on the timer information, the CPU 21 controls running actions and the like of running bodies (the model horses) 55 for the horse race gaming machine 11, and controls a rotation action of the roulette wheel 71 and the throwing of the ball for the roulette game machine 12.

Furthermore, an electric display unit 16 is connected to the CPU 21. The electric display unit 16 includes a plurality of light emitting elements such as LEDs, and the CPU 21 controls light emission of the light emitting elements, thereby giving effects by illumination, and displaying predetermined letters and characters on the electric display unit 16.

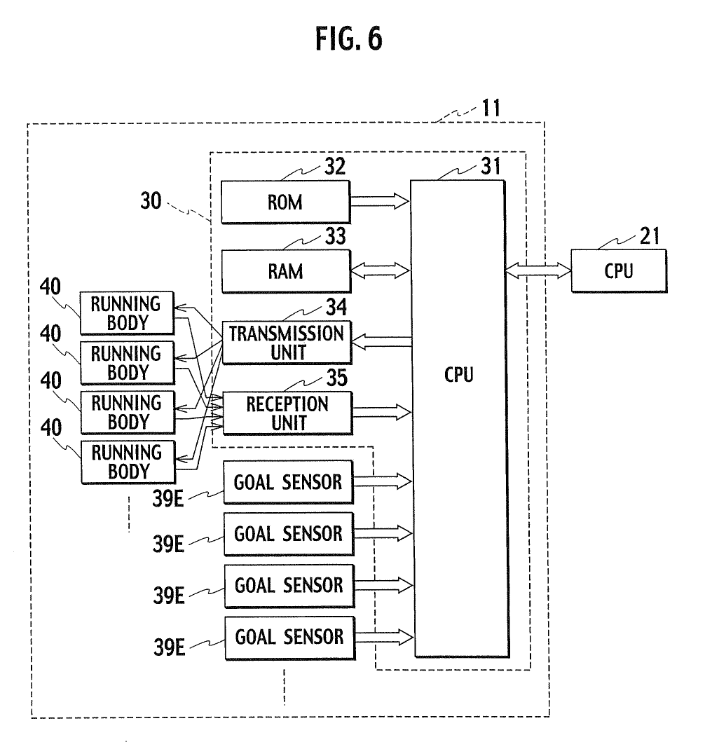

FIG. 6 is a block diagram showing a configuration of the horse race gaming machine 11 according to this embodiment. The horse race gaming machine 11 includes: a control unit 30; a plurality of running bodies 40; and a plurality of goal sensors 39E for individually detecting that the plurality of running bodies 40 have passed through a goal.

The control unit 30 includes a CPU 31, a ROM 32, a RAM 33, a transmission unit 34, and a reception unit 35. The ROM 32 is composed, for example, of a semiconductor memory or the like. The ROM 32 stores: the program for realizing the basic function of the horse race gaming machine 11; as well as varieties of programs and data tables, which are necessary to control the horse race gaming machine 11; and the like. The RAM 33 is a memory for temporarily storing a variety of data obtained by arithmetic operations in the CPU 31.

The transmission unit 34 is a wireless transmission unit for superimposing control data to control the plurality of running bodies 40 on carrier waves and transmitting the control data to the running bodies 40. The CPU 31 adds identifiers, which are assigned individually to the running bodies 40 as transmission destinations, to the control data to be transmitted, and then transmits the control data added with the identifiers from the transmission unit 34.

The reception unit 35 receives transmitted signals superimposed on carrier waves and transmitted from the running bodies 40. Then, the reception unit 35 extracts transmitted information from the received signals, and outputs the extracted information to the CPU 31. Identifiers for identifying the running bodies 40 as transmission sources are added to the transmitted information. The CPU 31 compares the received identifiers with the identifiers of the respective running bodies 40, which are pre-stored in the ROM 32, thereby specifying the running bodies 40 as the transmission sources. In such a way, the control unit 30 of the horse race gaming machine 11 controls the plurality of running bodies 40 individually.

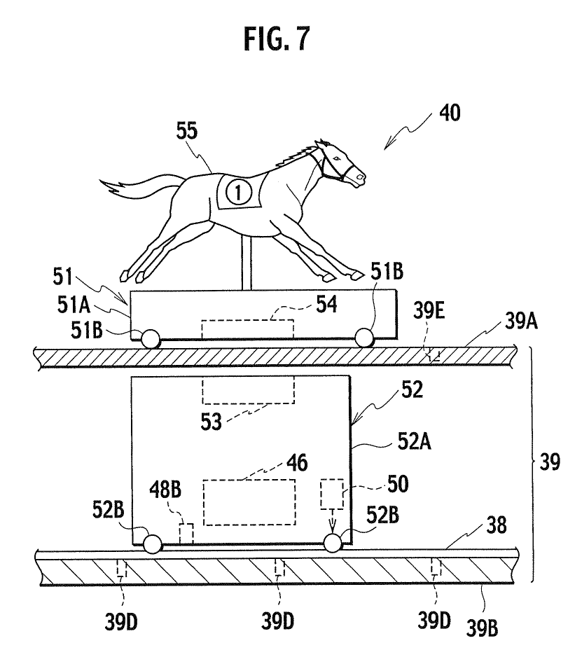

FIG. 7 is a side view showing a configuration of each of the running bodies 40. The running body 40 fixes the model horse 55, and runs on the circular track 39 (FIG. 2) in a circumferential direction thereof, in which the circular track 39 is provided in the horse race gaming machine 11. As shown in FIG. 7, the running body 40 includes an upper running body 51, and a lower running body 52. The track 39 is composed of: an upper track plate 39A for running the upper running body 51 thereon; and a lower track plate 39B for running the lower running body 52 thereon. On the lower track plate 39B, rails 38 for running the lower running body 52 thereon are provided along the circumferential direction of the track 39.

The upper running body 51 includes: a cabinet 51A that runs on the upper track plate 39A by tires 51B; and the model horse 55 fixed to the cabinet 51A. A magnet 54 is provided in the cabinet 51A.

The lower running body 52 includes a cabinet 52A. Wheels 52B are provided on the cabinet 52A, and the cabinet 52A runs on the rails 38 by the wheels 52B. Moreover, the cabinet 52A includes a control unit 46, a magnet 53, a Hall element 48B, and a motor 50. The control unit 46 makes a communication with the CPU 31 of the control unit 30 of the horse race gaming machine 11, thereby controlling an action of the lower running body 52. In such a way, the action of the lower running body 52 is controlled by the CPU 31. Specifically, the control unit 46 controls the motor 50 to run the lower running body 52.

The lower running body 52 and the upper running body 51 are attracted to each other by magnetic force generated between the magnets 53 and 54 thereof. The upper running body 51 runs on the upper track plate 39A following the running of the lower running body 52.

Here, in the lower track plate 39B, magnets 39D are embedded at a constant interval along the rails 38. When the lower running body 52 runs along the rails 38, changes of magnetic fields generated by the magnets 39D are detected by the Hall element 48B provided in the lower running body 52. The control unit 46 detects a running progress of the lower running body 52 based on the changes of the magnetic fields.

Moreover, on the upper track plate 39A, a goal point is set on a running route of each of the running bodies 40. At the goal point, a goal sensor 39E is provided on the running route of each of the running bodies 40. The goal sensor 39E includes a light emitting unit, and a light receiving unit. When the upper cabinet 51A passes through the goal point on the goal sensor 39E, light emitted from the light emitting unit is reflected on a bottom surface of the upper cabinet 51A, and is then received by the light receiving unit. The light receiving unit converts the received light having some light quantity into an electric signal, and outputs the electric signal to the CPU 31 of the control unit 30 (FIG. 6). The CPU 31 detects a change of the signal outputted from the goal sensor 39E, thereby detecting timing, at which the upper cabinet 51A has passed through the goal point, based on count values of an internal timer (not shown). The CPU 31 stores, in the RAM 33, the timing at which each of the running bodies 40 has reached the goal. After all of the running bodies 40 have reached the goal, the CPU 31 judges place orders of the respective running bodies 40 based on the timing at which each of the running bodies 40 has reached the goal, in which the timing is stored in the RAM 33. The place orders are transmitted from the control unit 30 to the CPU 21, and are stored in the RAM 23 of the control unit 13.

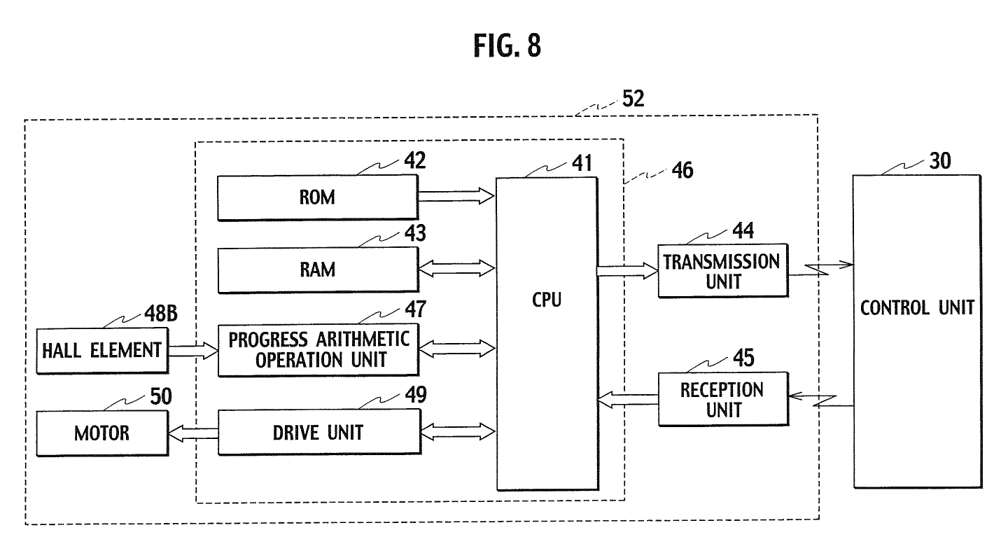

FIG. 8 is a block diagram showing a configuration of the lower running body 52. As shown in FIG. 8, the lower running body 52 includes: the control unit 46; a transmission unit 44 and a reception unit 45, which are for wirelessly transmitting and receiving information to and from the control unit 30 of the horse race gaming machine 11; the Hall element 48B for detecting the magnetism of the magnets 39D arranged along the running route of the lower running body 52 that runs along the lower track plate 39B (FIG. 7); and the motor 50 for running the lower running body 52.

The control unit 46 includes a CPU 41, a ROM 42, a RAM 43, a progress arithmetic operation unit 47, and a drive unit 49. The ROM 42 is composed, for example, of a semiconductor memory or the like. The ROM 42 stores: a program for realizing a basic function of the lower running body 49; as well as varieties of programs and data tables, which are necessary to control the lower running body 52; and the like. The RAM 43 is a memory for temporarily storing a variety of data obtained by arithmetic operations in the CPU 41. The progress arithmetic operation unit 47 arithmetically operates the progress of the lower running body 52 based on magnetism detection results outputted from the Hall element 48B. Based on an arithmetic operation result of the progress arithmetic operation unit 47 and the control data transmitted from the control unit 30, the CPU 41 performs a feedback control for the drive unit 49, thereby running the lower running body 52 at a speed corresponding to the control data from the control unit 30.

In such a way, the lower running body 52 runs on the rails 38 of the lower track plate 39B based on the control data transmitted from the control unit 30, and following such running of the lower running body 52, the upper running body 51 runs on the upper track plate 39A. From the above, an action is realized, which looks like as if the model horse 55 provided on the upper running body 51 ran on the track 39 (FIG. 2).

The control unit 30 of the horse race gaming machine 11 transmits the control data individually to the plurality of running bodies 40, whereby the respective running bodies 40 are individually controlled to run by the control of the control unit 30.

Based on the control data transmitted from the CPU 21 of the game apparatus 10, the CPU 31 of the horse race gaming machine 11 simultaneously starts to run the respective running bodies 40 from a starting position set on a part of the track 39. Then, the CPU 31 controls the respective running bodies 40 individually based on the control data. In such a way, the running bodies 40 run under individual running conditions (running speeds) thereof based on the control data.

Upon having detected that each of the running bodies 40 has reached the goal point, the CPU 31 of the control unit 30 (FIG. 6) transmits the control data to the control unit 46 of the running body 40 concerned, thereby stops the running of the running body 40.

After storing the place orders of the running bodies 40, which are transmitted from the control unit 30, in the RAM 23, the CPU 21 of the control unit 13 (FIG. 3) compares the place orders of the respective running bodies 40 with results of making the bets through the terminals 15, thereby calculating the payouts for each of the terminals. As described with reference to FIG. 5, the results of making the bets through the respective terminals 15 are transmitted to the control unit 13 from the terminals 15, and are stored in the bet information storage area 23A of the RAM 23.

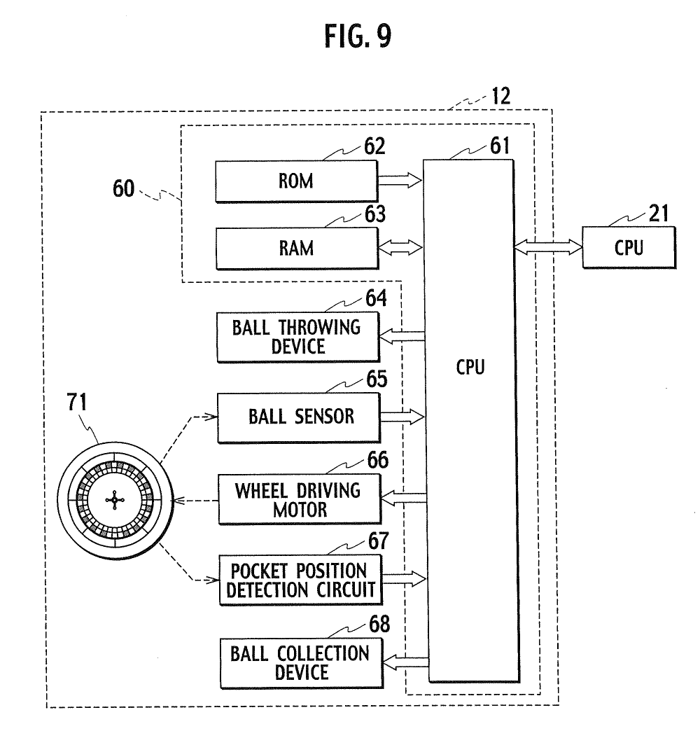

FIG. 9 is a block diagram showing a configuration of the roulette gaming machine 12 according to this embodiment. As shown in FIG. 9, the roulette gaming machine 12 includes the control unit 60, a ball throwing device 64, ball sensors 65, a wheel driving motor 66, a pocket position detection circuit 67, a ball collection device 68, and the roulette wheel 71.

The control unit 60 includes a CPU 61, a ROM 62, and a RAM 63. The ROM 62 is composed, for example, of a semiconductor memory or the like. The ROM 62 stores: the program for realizing the basic function of the roulette gaming machine 12; as well as varieties of programs and data tables, which are necessary to control the roulette gaming machine 12; and the like. The RAM 63 is a memory for temporarily storing a variety of data obtained by arithmetic operations in the CPU 61. The CPU 61 controls the launch of the ball and the rotation of the roulette wheel 71 based on the control data transmitted from the CPU 21 of the game apparatus 10, on the data stored in the ROM 62 and the RAM 63, and on the programs stored in the ROM 62 and the RAM 63.

The pocket position detection circuit 67 includes a proximity sensor. The pocket position detection circuit 67 detects a rotation position of the roulette wheel 71 based on whether or not a metal plate attached onto the roulette wheel 71 has been detected. In this case, the rotation position of the roulette wheel 71 corresponds to positions of number pockets (described later) provided on the roulette wheel 71.

The ball throwing device 64 is a device that throws the ball from a ball throwing opening (described later) onto the roulette wheel 71. The ball throwing device 64 launches the ball at an initial velocity designated by the control data, and throws the ball onto the roulette wheel 71.

The ball sensors 65 are devices for judging which number pocket the ball has entered.

The wheel driving motor 66 is a drive source for rotating the roulette wheel 71. The wheel driving motor 66 starts to drive by the control of the CPU 61. The CPU 61 stops the drive of the wheel driving motor 66 after elapse of a drive time of the motor, which is designated by the control data.

The ball collection device 68 is a device that collects the ball on the roulette wheel 71 after the game is ended.

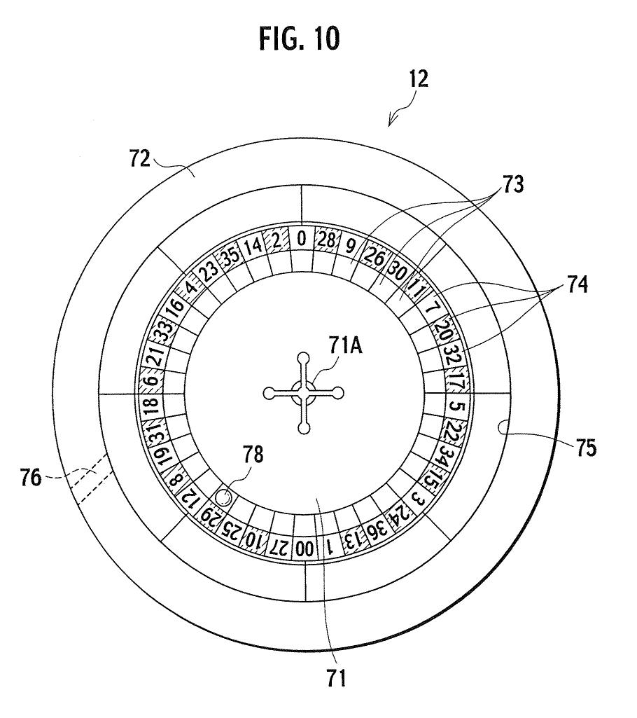

FIG. 10 is a plan view showing an exterior appearance of the roulette gaming machine 12 of the game apparatus 10 according to this embodiment.

As shown in FIG. 10, the roulette gaming machine 12 includes a frame body 72, and the roulette wheel 71. The frame body 72 is fixed to a cabinet of the game apparatus 10. The roulette wheel 71 is rotatably supported on an inside of the frame body 72. On the upper surface of the roulette wheel 71, the plurality (38 in this embodiment) of recessed number pockets 73 are formed. Moreover, on the upper surface of the roulette wheel 71, number display plates 74 which display numbers are formed on an outside of the respective number pockets 73 when viewed from a rotation center shaft 71A of the roulette wheel 71. On the number display plates 74, numbers (“0”, “00” and “1” to “36”) assigned to the number pockets 73 adjacent to the number display plates 74 concerned are written.

In an inner portion of the frame body 72, the ball throwing opening 76 for throwing the ball onto the upper surface of the roulette wheel 71 is provided. The ball throwing device 64 (FIG. 9) that throws the ball is provided on one end of the ball throwing opening 76. The ball throwing device 64 is a device for launching the ball 78 onto the upper surface of the roulette wheel 71. The ball 78 is launched by driving the ball throwing device 64. The launched ball 78 is thrown onto the roulette wheel 71 through the ball throwing opening 76.

An upper portion of the roulette gaming machine 12 is covered with a hemispherical cover 77 (FIG. 2) made of transparent acrylic resin.

The wheel driving motor 66 (FIG. 9) for rotating the roulette wheel is provided to a lower portion of the roulette wheel 71 concerned. The roulette wheel 71 rotates by the drive of the wheel driving motor 66. The CPU 61 rotates the roulette wheel 71 by the wheel driving motor 66 for a motor drive time designated by the control data. After the roulette wheel 71 is released from being driven by the wheel driving motor 66, a rotation speed of the roulette wheel 71 concerned is decreased gradually, and after a while, the roulette wheel 71 stops.

Moreover, metal plates (not shown) are attached at a predetermined interval onto the lower portion of the roulette wheel 71. The pocket position detection circuit 67 (FIG. 9) of the roulette gaming machine 12 detects the metal plates by a metal sensor included in the pocket position detection circuit 67, thereby detecting the positions of the number pockets 73.

The frame body 72 is gently inclined toward the inside of the roulette gaming machine 12. On an intermediate portion of such an inclined surface of the frame body 72, a guide wall 75 for guiding the ball is formed. The guide wall 75 guides the ball 78, which is thrown onto the roulette wheel 71, so that the ball 78 can resist centrifugal force. When the rotation speed is decreased and the centrifugal force is going to be lost, the ball 78 thrown onto the roulette wheel 71 from the ball throwing opening 76 rolls down on the inclined surface of the frame body 72, goes toward the inside of the roulette gaming machine 12, and falls down on the upper surface of the rotating roulette wheel 71. Then, the ball 78 that has rolled onto the roulette wheel 71 passes on the number display plates 74 of the roulette wheel 71 that still rotates, and enters any of the number pockets 73. In the respective number pockets 73, the ball sensors 65 (FIG. 9) for detecting that the ball 78 has entered the same are provided. Based on detection results of the ball sensors 65, the CPU 61 of the roulette gaming machine 12 judges a number corresponding to the number pocket 73 which the ball 78 has entered. The judged number becomes the winning number. The winning number in this case is a number written on one of the number display plates 74 adjacent to the number pockets 73.

In such a way, in the roulette gaming machine 12, based on the control data from the CPU 21 of the game apparatus 10, the roulette wheel 71 is rotated, the ball 78 is thrown onto the rotating roulette wheel 71, the number of the number pocket 73 which the thrown ball 78 has entered is judged, and the result of the judgment is outputted from the roulette gaming machine 12 to the CPU 21 of the game apparatus 10.

Based on the above-described result of the judgment and the result of making the bet in each of the terminals 15, the CPU 21 calculates the payout for each of the terminals 15. The result of making the bet in each of the terminals 15 is transmitted from the terminal 15 to the control unit 13, and is stored in the RAM 23 of the control unit 13.

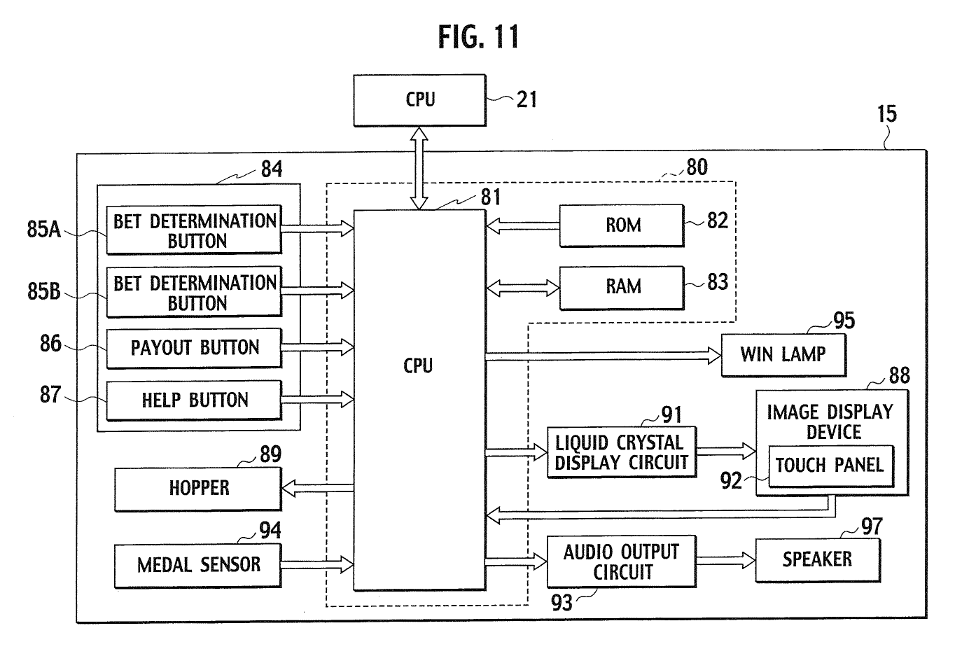

FIG. 11 is a block diagram showing an internal configuration of the terminal 15 according to this embodiment. Note that the terminals 15 provided by the plural pieces have basically the same configuration, and a description will be made here of one terminal 15.

As shown in FIG. 11, the terminal 15 includes a terminal control unit 80, a switch unit 84, an image display device 88, a hopper 89, a medal sensor 94, a WIN lamp 95, and speaker 97. The terminal control unit 80 includes a CPU 81, a ROM 82, and a RAM 83. The ROM 82 is composed, for example, of a semiconductor memory or the like. The ROM 82 stores: a program for realizing a basic function of the terminal 15; as well as varieties of programs and data tables, which are necessary to control the terminal 15; and the like. The RAM 83 is a memory for temporarily storing: the respective game results of the horse race game and the roulette game, which are transmitted from the control unit 13; a variety of data obtained by arithmetic operations in the CPU 81; the number of credits owned by the terminal 15; the result (the bet information) of making the bet in the terminal 15; and the like.

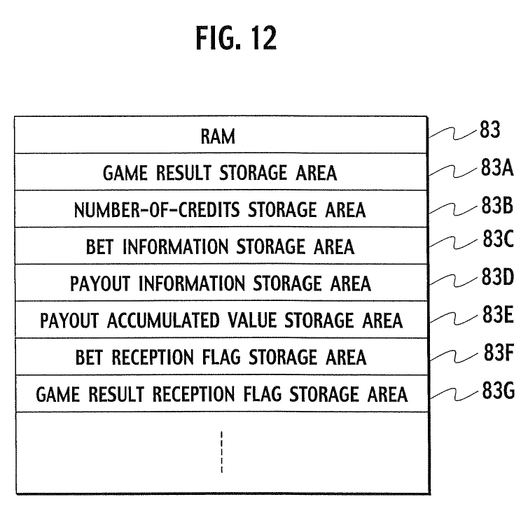

FIG. 12 is a schematic diagram showing a storage area of the RAM 83. As shown in FIG. 12, the RAM 83 includes a game result storage area 83A, a number-of-credits storage area 83B, a bet information storage area 83C, a payout information storage area 83D, a payout accumulated value storage area 83E, and the like. The game result storage area 83A stores the game results of the horse race game and the roulette game, which are received from the control unit 13. The number-of-credits storage area 83B stores the number of credits owned by the terminal 15 (the player). The number of credits is managed by the control unit 13, and is transmitted from the control unit 13 to the terminal 15. The bet information storage area 83C stores the number of bets made for each of the games in the terminal 15. The payout information storage area 83D stores, for each of the games, information (payout information) indicating a magnitude of the award regarding the horse race game and payout information regarding the roulette game. These pieces of information are received from the control unit 13. The accumulated value storage area 83E stores an accumulated value of the payout information regarding the horse race game, and an accumulated value of the payout information regarding the roulette game.

To the CPU 81 (FIG. 11), there are individually connected bet determination buttons 85A and 85B, a payout button 86, and a help button 87, which are provided in the switch unit 84.

The bet determination buttons 85A and 85B are press buttons for determining the bets after betting operations are performed through a touch panel 92 of the image display device 88. The bet determination button 85A is a button for determining the bet made on the horse race game, and the bet determination button 85B is a button for determining the bet made on the roulette game.

The payout button 86 is a button pressed usually when the game is ended. When the payout button 86 is pressed, medals of the number corresponding to the number of credits acquired by the player on the game are paid out from a medal payout opening 96 (FIG. 2). In usual, the number of medals thus paid out is one for one credit. The number of credits is stored in the number-of-credits storage area 23D of the RAM 23 of the control unit 13.

The help button 87 is a button pressed when an operation method and the like of the game are unknown. When the help button 87 is pressed, a help screen that shows a variety of operation information is displayed on the image display device 88 immediately thereafter.

Processing related to the above-described buttons is executed by the CPU 81 that receives operation results of the respective buttons.

Based on operation signals outputted from the switch unit 84 in such a manner that the respective buttons of the switch unit 84 are pressed, and so on, the CPU 81 executes the variety of processing corresponding to the operation signals. Specifically, based on the signals supplied from the switch unit 84 based on the operations of the player, and based on the data and the programs, which are stored in the ROM 82 and the RAM 83, the CPU 81 executes the variety of processing, and transmits results thereof to the CPU 21 of the control unit 13 (FIG. 3) of the game apparatus 10.

Meanwhile, the CPU 81 receives the control data from the CPU 21, controls peripheral instruments composing the terminal 15, and progresses the game in the terminal 15. Moreover, based on the operation signals outputted from the switch unit 84 based on the input operations of the player, and based on the data and the programs, which are stored in the ROM 82 and the RAM 83, the CPU 81 executes a variety of processing. Then, based on results of executing the processing, the CPU 81 controls the peripheral instruments composing the terminal 15, and progresses the game.

The hopper 89 is connected to the CPU 81. The hopper 89 pays out a predetermined number of medals from the medal payout opening 96 (FIG. 2) based on the control data from the CPU 81.

Moreover, to the CPU 81, there is connected the image display device 88 through a liquid crystal display circuit 91. The liquid crystal display circuit 91 includes a program ROM, an image ROM, an image control CPU, a work RAM, a video display processor (VDP), and a video RAM. The program ROM stores an image controlling program and a variety of selection tables, which are related to display on the image display device 88. The image ROM stores, for example, dot data for forming an image displayed by the image display device 88. The image control CPU is one to decide the image to be displayed on the image display device 88 from among the dot data, which is pre-stored in the image ROM, based on a parameter set by the CPU 81 in accordance with an image control program pre-stored in the program ROM. The work RAM is composed as a temporal storage device when the image control program is executed by the image control CPU. The VDP is one to form the image corresponding to display contents decided by the image control CPU, and to output the formed image to the image display device 88. The video RAM is composed as a temporal storage area when the image is formed by the VDP.

The touch panel 92 is provided on a front surface of the image display device 88. A result of operating the touch panel 92 is transmitted to the CPU 81. Based on the result of operating the touch panel 92, the CPU 81 receives the bets on the horse race game and the roulette game individually. Upon receiving the bets, the CPU 81 transmits results (the bet information) of the reception to the control unit 13 of the game apparatus 10. The CPU 21 of the control unit 13 stores the bet information in the RAM 23. Processing of receiving the bets will be described later.

The speaker 97 is connected to the CPU 81 through an audio output circuit 93. The speaker 97 generates a variety of effect sounds based on output signals from the audio output circuit 93.

Moreover, the medal sensor 94 is connected to the CPU 81. The medal sensor 94 detects the medals inserted in from a medal insertion slot 98 (FIG. 2), and outputs a result of detecting the medals to the CPU 81. Based on the result of such detection, which is outputted from the medal sensor 94, the CPU 81 counts the number of inserted medals, and then transmits a result of counting the number to the control unit 13 (FIG. 3). Based on the result of such counting, which is transmitted from the terminal 15, the CPU 21 of the control unit 13 increases the number of credits owned by the terminal 15, in which the number is stored in the RAM 23.

Furthermore, the WIN lamp 95 is connected to the CPU 81. When the result of making the bet on the horse race game or the roulette game results in a winning, the CPU 21 of the control unit 13 (FIG. 3) turns on the WIN lamp 95 of the terminal 15 that has got the winning.

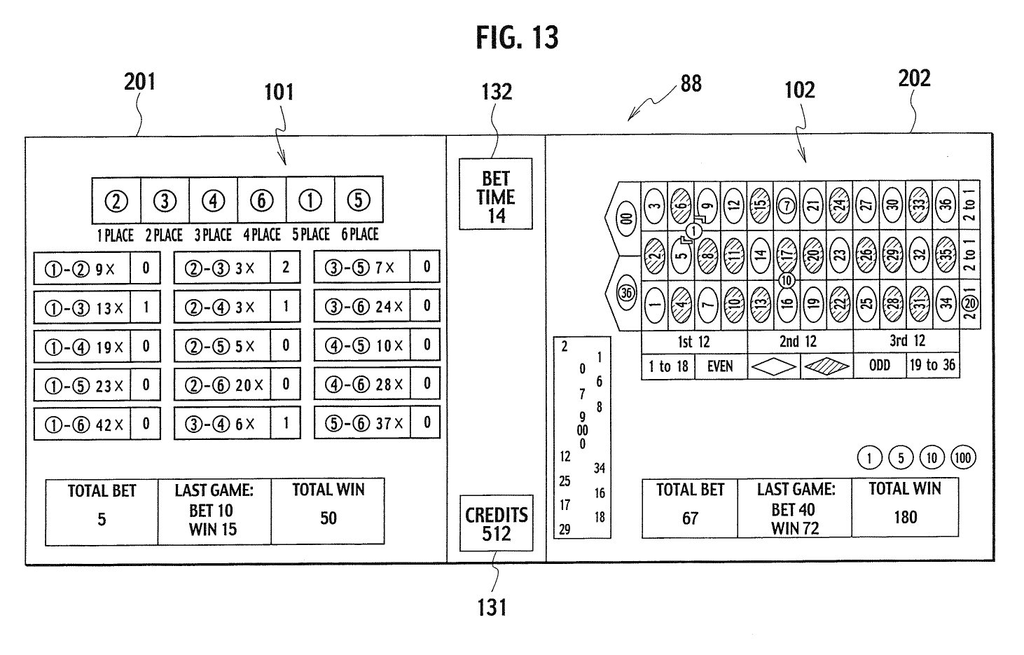

The terminal control unit 80 of the terminal 15 displays, on the image display device 88, a bet screen for receiving the bets. As shown in FIG. 13, on the bet screen, there are displayed: the first window 101 for receiving the bet to the horse race gaming machine 11; and the second window 102 for receiving the bet to the roulette gaming machine 12. An image for receiving the bet on the horse race game is displayed on the first window 101. When a pressing operation is performed for the touch panel 92 provided on a surface of such a display screen on which the above-described image (of switches) is displayed, a result of the pressing operation (a result of operating a switch) is outputted from the touch panel 92 to the CPU 81. Meanwhile, an image for receiving the bet on the roulette game is displayed on the second window 102. When a pressing operation is performed for the touch panel 92 provided on a surface of such a display screen on which the above-described image of switches is displayed, a result of operating a switch is outputted from the touch panel 92 to the CPU 81.

Based on signals, which represent the results of such pressing and are outputted from the touch panel 92 provided on the first window 101 and the second window 102, the CPU 81 judges which of the horse race game and the roulette game the bet has been made on, and judges contents of the bet made thereon.

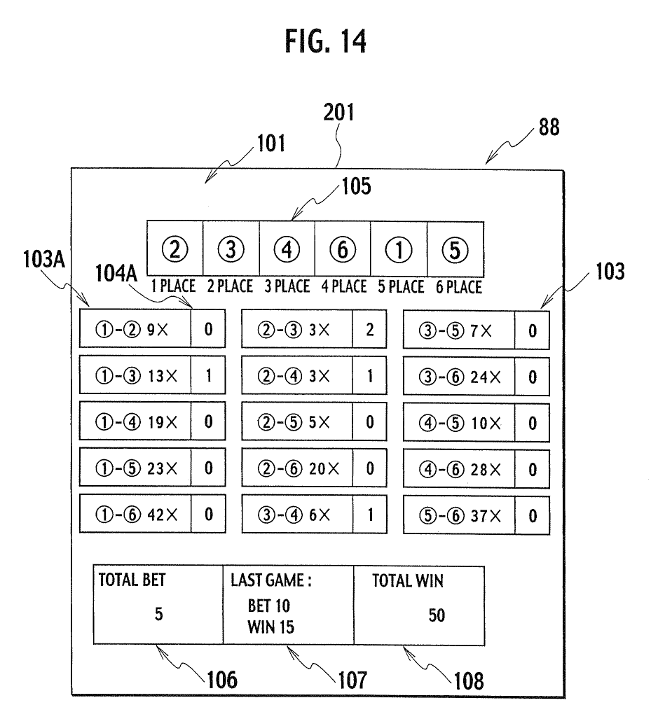

FIG. 14 shows details of the first window 101. The first window 101 includes a bet region 103 for casting a vote according to a quinella or exacta voting method for each of the horse race games. On the bet region 103, payouts for combinations of the respective horse numbers are displayed. For example, a region surrounded by a payout display frame 103A indicates that a payout of nine times can be obtained with respect to a bet on a combination of horse numbers “1” and “2”. In line with the payout display frame 103A, a bet display frame 104A is displayed. When the touch panel 92 provided on a surface of a region surrounded by the bet display frame 104A is operated to be pressed, a result of such an operation is outputted from the touch panel 92 to the CPU 81. Every time when the CPU 81 receives the result of the operation, the CPU 81 gives an increment to the number in the bet display frame 104A in order from 0, and stores, in the RAM 83, results of the increments in association with the combinations of the horse numbers displayed on the payout display frame 103A. A display example shown in FIG. 14 shows a display state of the bet region 103 in the case where: one medal is bet on a combination of the horse numbers “1” and “3”; two medals are bet on a combination of the horse numbers “2” and “3”; one medal is bet on a combination of the horse numbers “2” and “4; and one medal is bet on a combination of the horse numbers “3” and “4”. When the touch panel 92 of the bet region 103 is operated to be pressed, the CPU 81 judges the contents of the bet made by such a pressing operation. Here, the contents are the combination of the horse numbers in which the number of bets on the bet display frame 104A is one or more. Then, the CPU 81 temporarily stores the contents of the bet as the bet information in the RAM 83. Thereafter, when the bet determination button 85A for the horse race game is operated, the CPU 81 transmits, to the control unit 13 (FIG. 3), the bet information stored in the RAM 83.

Moreover, the first window 101 includes a place order display region 105. On the place order display region 105, the CPU 81 displays a result of a horse race executed last time. Here, the result shows place orders of all the horses. The result of the horse race game is information that is outputted to the control unit 13 of the game apparatus 10 from the horse race gaming machine 11, and is stored in the winning number storage area 23B (FIG. 5) of the RAM 23 of the control unit 13. Every time when the result of the game is obtained (that is, every time when one game is ended), the control unit 13 stores, in the RAM 23, the result of the game, which is obtained from the horse race gaming machine 11, and transmits the result of the game to the respective terminals 15. In such a way, in the respective terminals 15, every time when one game is ended in the horse race gaming machine 11, the result of the game is displayed on the first windows 101 of the image display devices 88.

Incidentally, the display of the result of the horse race game is continued until the next horse race game is started.

Moreover, the first window 101 includes a total number-of-bets display region 106. The CPU 81 counts the total number of medals bet on the bet region 103 for each of the horse race games, stores a result of such counting in the RAM 83, and displays the total number concerned on the total number-of-bets display region 106.

Furthermore, the first window 101 includes a last-game display region 107. The CPU 81 stores the total number of bets in the RAM 83 for each of the horse race games. In addition, the CPU 81 receives, from the control unit 13, information indicating a magnitude of the award (that is, the number of medals) generated based on the result of the game, and stores the received information in the RAM 83. Then, the CPU 81 displays such pieces of information on the last-game display region 107 of the first window 101. Between these pieces of information thus displayed, the information indicating the total number of bets is started to be displayed when the total number of bets is determined by the operation of the bet determination button 85A (FIG. 11). Meanwhile, the information indicating the magnitude of the award is started to be displayed when the information indicating the magnitude of the award is transmitted to the terminal 15 from the control unit 13 after one horse race game is ended. These pieces of information are continued to be displayed until a bet on the next game is started to be made.

Moreover, the first window 101 includes a total number-of-payouts display region 108. Every time when the CPU 81 receives, from the control unit 13, the information (the payout information) indicating the magnitude of the award generated in the horse race game, the CPU 81 stores the payout information in the payout information storage area 83D (FIG. 12) of the RAM 83. In addition, the CPU 81 accumulates a result of the payout provided each time, and stores an accumulated value thus obtained in the payout accumulated value storage area 83E (FIG. 12) of the RAM 83. The CPU 81 reads out the accumulated value from the RAM 83, and displays the accumulated value on the total number-of-payouts display region 108. The CPU 81 continues to calculate the accumulated value and to store the calculated value in the RAM 83 until the total number-of-payouts display region 108 is operated to be pressed. When the total number-of-payouts display region 108 is operated to be pressed, the CPU 81 resets the accumulated value of the number of payouts (that is, rewrites the accumulated value to “0”) regarding the horse race game, which is stored in the RAM 83, and resumes such accumulation from a result of the next horse race game. In such a way, on the total number-of-payouts display region 108, there is displayed an accumulated value of magnitudes of awards (that is, the number of payouts) obtained in the respective horse race games after the accumulated value is reset.

Based on the display of the total number-of-payouts display region 108, the player can confirm a result of the accumulation of the payouts obtained in the horse race games.

As described above, regarding the horse race game, on the first window, there are displayed the screen for the operation for allowing the player to make the bet, and the results of the horse race games.

In such a way, through the first window 101, the player can make the bet on the horse race game, and can get to know the results of the horse race game.

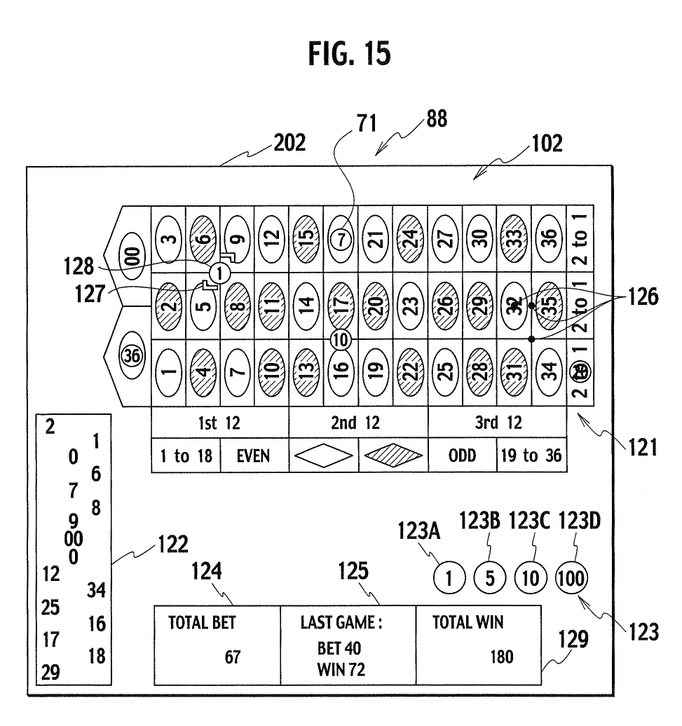

FIG. 15 shows details of the second window 102. On the second window 102, an image 121 is displayed. The image 121 shows a table-type betting board for betting a medal on the roulette game every time. When a pressing operation is performed for the touch panel 92 provided on the display surface located at a position where the image 121 showing the table-type betting board is displayed, a result of the pressing operation is outputted from the touch panel 92 to the CPU 81. The CPU 81 receives the bet on the roulette game based on a result of operating the touch panel 92.

First, based on FIG. 15, a description will be made of the table-type betting board 121 displayed during the game. On the table-type betting board 121, 38 types of numbers, which are “0”, “00” and “1” to “36”, are arrayed and displayed on squares. Moreover, special bet regions for betting medals by designating “odd numbers”, “even numbers”, “type of colors (red or black) of number display plates” and “fixed number ranges (for example, “1” to “12” and the like) are also displayed on squares in a similar way.

Below the table-type betting board 121, there are provided: a result history display region 122; unit bet buttons 123; a total number-of-bets display region 124; and a last-game display region 125.

On the result history display region 122, results of wining numbers in the last game and before are displayed as a list. Here, one game refers to a series of operations, in which the player first makes a bet in each of the terminals 15, the ball 78 then enters any of the number pockets 73, and the credits are finally paid out based on a winning number. Every time when one game is ended, display of a new winning number is added to the list from the above. Thereafter, a history of the winning numbers of 16 games at the maximum is displayed on the list. The winning numbers in the past games, which are displayed on the result history display region 122, are results of the games, each of which is outputted from the roulette gaming machine 12 to the control unit 13 every time when one roulette game is ended. Every time when the control unit 13 receives the result of each game from the roulette gaming machine 12, the control unit 13 transmits the result concerned to the respective terminals 15. Every time when each of the terminals 15 receives the result of the game, the terminal 15 stores the result of the game in the RAM 83, and displays the stored result of the game on the result history display region 122.

Moreover, the unit bet buttons 123 are buttons for betting the medal on any of bet areas 126 designated by the player. Here, the bet areas 126 are areas on the squares of the numbers and the marks, or areas on lines which form the squares. The unit bet buttons 123 are composed of four types of buttons, which are: a 1-BET button 123A; a 5-BET button 123B; a 10-BET button 123C; and a 100-BET button 123D.

First, on the displayed screen, the player directly presses, by the finger and the like, the bet area 126 on which the bet is to be made, thereby setting a cursor 127 to be described later on the screen, and designates the area by the cursor 127. When the 1-BET button 123A is pressed in this state, the medals are bet one by one. The number of bet medals is increased in an order of “1”→“2”→“3”→ . . . every time when the 1-BET button 123A is pressed by the finger and the like. When the 5-BET button 123B is pressed, the medals are bet five by five. The number of bet medals is increased in an order of “5”→“10”→“15”→ . . . every time when the 5-BET button 123B is pressed by the finger and the like. When the 10-BET button 123C is pressed, the medals are bet ten by ten. The number of bet medals is increased in an order of “10”→“20”→“30”→ . . . every time when the 10-BET button 123C is pressed by the finger and the like. When the 100-BET button 123D is pressed, the medals are bet hundred by hundred. The number of bet medals is increased in an order of “100”→“200”→“300”→ . . . every time when the 100-BET button 123D is pressed by the finger and the like.

The total number-of-bets display region 124 is a region that displays the total number of medals bet on each of the roulette games. For each of the roulette games, the CPU 81 counts the total number of medals bet on the table-type betting board 121, stores a result of the counting in the RAM 83, and displays the result of the counting on the total number-of-bets display region 124.

The last-game display region 125 is a region that displays the number of medals bet by the player and the magnitude of the award (the number of medals) as a result of the game in the last game. For each of the roulette games, the CPU 81 stores the total number of bets in the RAM 83, receives, from the control unit 13, information indicating the magnitude of the award (the number of medals) generated based on the result of the game, and stores the information in the RAM 83. Then, the CPU 81 displays such pieces of information on the last-game display region 125. Between these pieces of information thus displayed, the information indicating the total number of bets is started to be displayed when the total number of bets is determined by the operation of the bet determination button 85B (FIG. 11). Meanwhile, the information indicating the magnitude of the award is started to be displayed when the information indicating the magnitude of the award is transmitted to the terminal 15 from the control unit 13 after one roulette game is ended. These pieces of information are continued to be displayed until a bet on the next game is started to be made.

The cursor 127 indicating the bet area 126 selected at present by the player is displayed on the table-type betting board 121. Moreover, on the table-type betting board 121, a medal mark 128 indicating the number of medals bet by this point of time and indicating the bet area 126 is displayed. A number displayed on the medal mark 128 indicates the number of bet medals. For example, as shown in FIG. 15, a medal mark 71 of “7”, which is placed on a square of “18”, indicates that seven medals are bet on the number “18”. Such a method of making the bet on only one number is a betting method called “straight bet”.

Moreover, a medal mark 128 of “1”, which is placed on an intersection of squares “5”, “6”, “8” and “9”, indicates that one medal is bet so as to cover four numbers of “5”, “6”, “8” and “9”. Such a method of making the bet so as to cover four numbers is a betting method called “corner bet”.

As other betting methods, the following methods are present. First, there is “split bet” in which the bet is made on a line between two numbers so as to cover the two numbers. Next, there is “street bet” in which the bet is made on an end of one lateral row (one longitudinal column in FIG. 15) so as to cover three numbers (for example, “13”, “14” and “15”) Next, there is “five bet” in which the bet is made on a line between the numbers “00” and “3” so as to cover five numbers “0”, “00”, “1”, “2” and “3”. Next, there is “line bet” in which the bet is made between two lateral rows (two longitudinal columns in FIG. 15) so as to cover six numbers (for example, “13”, “14”, “15”, “16”, “17” and “18”). Next, there is “column bet” in which the bet is made on a square, on which “2 to 1” is written, so as to cover twelve numbers. Next, there is “dozen bet” in which the bet is made on squares, on which “1st 12”, “2nd 12” and “3rd 12” are written, so as to cover twelve numbers on each of the squares. Moreover, there is a betting method in which, by using six squares provided on the lowermost stage of the table-type betting board 121, the bet is made so as to cover eighteen numbers depending on whether a color of the number display plates is red or black, whether the numbers are odd or even, or whether the numbers are 18 or less or 19 or more. Here, in these plural betting methods, the payouts of credits (the payout multiplication factors) per medal when the bet medals win the awards differ from one another.

When the player makes the bet on the bet screen configured as described above, the player first directly presses, on the screen, a bet area 126 (on a square of the number or the mark, or on the line forming the squares), on which the bet is to be made, thereby designating the bet area 126. As a result, the cursor 127 moves to the designated bet area 126.

Thereafter, the player presses any of the unit buttons (the 1-BET button 123A, the 5-BET button 123B, the 10-BET button 123C and the 100-BET button 123D) of the unit bet buttons 123, whereby medals corresponding to the unit number of the pressed button are bet on the bet area 126. For example, if the 10-BET button 123C is pressed four times, the five-BET button 123B is pressed once, and the 1-BET button 123A is pressed three times, then 48 medals in total are bet.

When the touch panel 92 of the bet area 126 is operated to be pressed, the CPU 81 judges the contents of the bet made by such a pressing operation, and temporarily stores the contents of the bet as bet information in the RAM 83. Then, when the bet determination button 85B for the roulette game is operated, the CPU 81 transmits, to the control unit 13 (FIG. 3), the bet information stored in the RAM 83.

As described above, regarding the roulette game, on the second window 102, there is displayed the image for the operation for allowing the player to make the bet.

In such a way, through the second window 102, the player can make the bet on the roulette game.

Moreover, the second window 102 includes a total number-of-payouts display region 129. Every time when the CPU 81 receives, from the control unit 13, the magnitude of the award (that is, the payout) generated in the roulette game, the CPU 81 stores the payout in the payout information storage area 83D (FIG. 12). In addition, the CPU 81 accumulates a result of the payout provided each time, and stores an accumulated value thus obtained in the payout accumulated value storage area 83E (FIG. 12) of the RAM 83. The CPU 81 reads out the accumulated value from the RAM 83, and displays the accumulated value on the total number-of-payouts display region 129. The CPU 81 continues to calculate the accumulated value and to store the calculated value in the RAM 83 until the total number-of-payouts display region 129 is operated to be pressed. When the total number-of-payouts display region 129 is operated to be pressed, the CPU 81 resets the accumulated value of the number of payouts (that is, rewrites the accumulated value to “0”) regarding the roulette game, which is stored in the RAM 83, and resumes such accumulation from a result of the next roulette game. In such a way, on the total number-of-payouts display region 129, there is displayed an accumulated value of magnitudes of awards (that is, the number of payouts) obtained in the respective roulette games after the accumulated value is reset.

Based on the display of the total number-of-payouts display region 129, the player can confirm a result of the accumulation of the payouts obtained in the roulette games.

Moreover, as shown in FIG. 13, the number-of-credits display region 131 and the betting time display region 132 are provided between the first window 101 and the second window 102. The number-of-credits display region 131 and the betting time display region 132 are ones provided commonly to the horse race game displayed on the first widow 101 and the roulette game displayed on the second windows 102. On the number-of-credits display region 131, the number of credits owned by the player at present is displayed. The number of credits is stored in the number-of-credits storage area 23D of the RAM 23 of the control unit 13 in association with each of the terminals 15. When the number of credits is changed, the CPU 21 of the control unit 13 updates the number of credits, which is stored in the RAM 23, and then transmits a result of the update together with an identifier of the terminal concerned to the terminal 15. The number of credits is reduced when the player bets the medals, and is increased when the payout is provided as a result of the game.

Upon receiving the number of credits, which is transmitted thereto from the control unit 13, the terminal 15 updates the number of credits, which is stored in the RAM 83, and displays the updated number of credits on the number-of-credits display region 131.

In such a way, the number of credits, which is displayed on the number-of-credits display region 131, is updated in real time when the input of the bet is received, when the payout is provided in response to the result of the game, and so on.

Moreover, on the betting time display region 132, the remaining time while the player is being capable of making the bets is displayed. The CPU 81 displays a preset betting time (20 seconds in the case of this embodiment) on the betting time display region 132 at a point of time when both of the horse race game and the roulette game are ended. Simultaneously at the time of this display, the CPU 81 activates an internal timer, and based on a result of such counting, reduces a number displayed as the betting time one by one. In such a way, the betting time displayed on the betting time display region 132 is reduced in response to the remaining time while the player is being capable of making the bets. The CPU 81 finishes receiving the bets at the point of time when the betting time reaches “0”. The CPU 81 changes the display on the betting time display region 132 from blue to yellow at the point of time when the remaining time of the betting time reaches 10 seconds, and changes the display concerned from yellow to red at the point of time when the remaining time reaches 5 seconds. In such a way, the remaining time of the betting time becomes more easily understandable. In place of changing the color of the display in response to the remaining time, for example, a configuration may be adopted, in which the betting time display region 132 is made to blink the light, and a cycle of the blink is shortened as the remaining time is being reduced.

From the above, at the point of time when the horse race game and the roulette game are ended and the reception of the betting operations is started, “20” is displayed on the number-of-bets display region 132, and the number concerned is reduced one by one by every second. Then, when the number reaches “0”, the reception of the betting operations is ended.

When the remaining betting time is reduced to 5 seconds, the CPU 81 outputs a voice as an announcement of the start of the games from the speaker 97 of the terminal 15. Then, when the remaining betting time reaches “0”, the CPU 81 issues, to the control unit 13, a notice that the reception of the bets is ended. In such a way, the CPU 21 of the control unit 13 instructs the horse race gaming machine 11 and the roulette gaming machine 12 to start the games.

Upon being instructed to start the game, the horse race gaming machine 11 allows the respective running bodies 40 (FIG. 7) to start running from the start point. Upon being instructed to start the game, the roulette gaming machine 12 drives the ball throwing device 64, thereby throwing the ball 78 onto the roulette board.

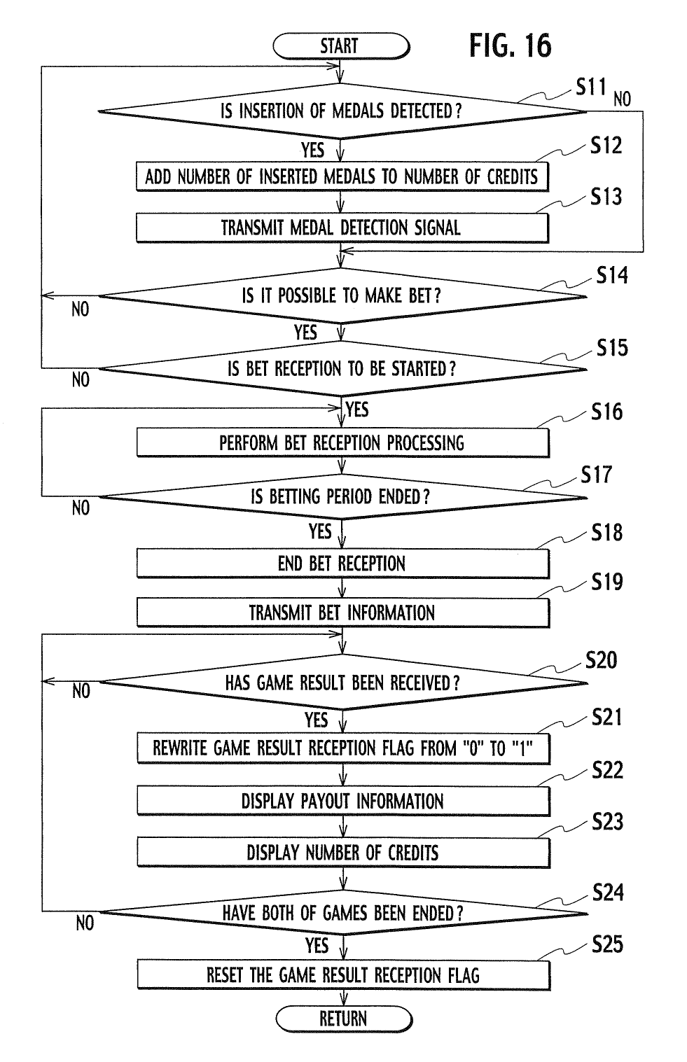

Next, a description will be made of a series of operations from the bet reception processing in the terminal 15 to the game execution in the game apparatus 10. FIG. 16 is a flowchart showing a series of processing from processing for receiving the bets in the terminal 15 to processing for providing the payouts based on the results of the games.

As shown in FIG. 16, in Step S11, the CPU 81 judges whether or not the medals have been inserted based on the detection result of the medal sensor 94. When a negative result is obtained in Step S11, this stands for that no medal has been inserted, and the CPU 81 proceeds to Step S14 to be described later. On the contrary, when a positive result is obtained in Step S11, this stands for that the medals have been inserted from the medal insertion slot 98, and the CPU 81 proceeds from Step S11 to Step S12.

In Step S12, the CPU 81 adds the number of inserted medals to the number of credits, which is stored in the RAM 83. In Step S13 that follows, the CPU 81 transmits an increment of the number of credits as a medal detection signal to the control unit 13. The control unit 13 stores such received credit data in the RAM 23. Note that the terminal 15 receives the medals at any time even during the games, and therefore, the update of the number of credits in the RAM 83 and the transmission of the medal detection signal, which are performed in accordance with the result of inserting the medals, are performed at any time.

In Step S14, the CPU 81 judges whether or not it is possible to make the bets based on the number of credits, which is stored in the RAM 83 (that is, the number of credits owned by the terminal 15). In the case of this embodiment, it is possible to make the bet even by using only one medal. Accordingly, when the number of credits, which is stored in the RAM 83, is one or more, the CPU 81 proceeds from Step S14 to Step S15 by obtaining a positive result in Step S14. Meanwhile, when the number of credits, which is stored in the RAM 83, is 0, the CPU 81 returns to Step S11 described above by obtaining a negative result in Step S14. In such a way, the CPU 81 repeats the processing of Step S11 to Step S14 until it becomes possible to make the bets in such a manner that the medals are inserted.

In Step S15, the CPU 81 judges whether or not the reception of the bets is to be started based on bet reception flags stored in a bet reception flag storage area 83F of the RAM 83. The bet reception flags turn to a state of permitting the reception of the bets when both of the horse race game and the roulette game are ended. Specifically, when the games are ended in the horse race gaming machine 11 and the roulette gaming machine 12, the respective gaming machines transmit results of the games to the control unit 13. The control unit 13 transmits payouts, which are based on the results of the games, to the terminal 15. When the terminal 15 finishes receiving the payouts of both of the horse race game and the roulette game, the terminal 15 changes the bet reception flags in the RAM 83 from a bet-prohibiting state to such a bet-permitting state. When the bet reception flags turn to the bet-permitting state, the CPU 81 starts to receive the bets. Specifically, the terminal 15 starts to receive the bets at the point of time when both of the horse race game and the roulette game are ended. Hence, when the bet reception flags in the RAM 83 are in the bet-prohibiting state, the CPU 81 repeats the processing of Step S14 until the flags concerned turn to the bet-permitting state. When the bet reception flags turn to the bet-permitting state, the CPU 81 proceeds from Step S15 to Step S16.

In Step S16, the CPU 81 displays the bet screen (FIG. 13) for receiving the bets on the image display device 88, and receives the bets on the horse race game and the roulette game. The CPU 81 temporarily stores, in the RAM 83, the result of the input in the first window 101 as bet information on the horse race game, and the result of the input in the second window 102 as bet information on the roulette game.

Note that, when the CPU 81 starts to receive the bets in Step S16, the CPU 81 activates the internal timer, and counts elapse of time from the point of time of starting to receive the bets. Then, the CPU 81 proceeds to Step S17, and judges whether or not a reception period for the bets (that is, a betting period) has been ended based on the elapse of the time, which is obtained from the internal timer.

When a negative result is obtained in Step S17, this stands for that such a bet reception period has not been ended, and the CPU 81 returns to Step S16 described above, and repeats the bet reception processing. As described above, during the betting period, the reception of the bet on the horse race game and the reception of the bet on the roulette game are performed simultaneously.

Then, in the case of having determined that the bet reception period is ended based on the result of counting such a time course by the internal timer, the CPU 81 obtains a positive result in Step S17 (FIG. 16), thereby proceeding from Step S17 to Step S18, and ending the reception of the bets.

After ending the reception of the bets, in Step S19, the CPU 81 transmits the bet information regarding the horse race game and the roulette game, which is stored in the RAM 83 during the bet reception period, to the control unit 13.

When the bet information is transmitted from the terminal 15 to the control unit 13 after the bet reception is ended, the control unit 13 controls the horse race gaming machine 11 and the roulette gaming machine 12, whereby the horse race game and the roulette game are started.

When the horse race game and the roulette game are ended, the information (the number of acquired medals) indicating the magnitudes of the awards is transmitted as the results of the games from the control unit 13 to the terminal 15. The terminal 15 receives the results of the games, thereby storing the magnitudes of the acquired awards (that is, the number of medals) in the payout information storage area 83D of the RAM 13. In addition, the terminal 15 displays the magnitudes of the acquired awards on the windows, and executes the processing corresponding to the results of the games. Note that, on the RAM 23, the control unit 13 updates the number of credits owned by the terminal 15 based on the magnitudes of the awards acquired by the terminal 15 concerned. The control unit 13 also transmits a result of such update together with the information indicating the magnitudes of the awards to the terminal 15. Based on the information, the terminal 15 updates the number of credits, which is stored in the number-of-credits storage area 83B of the RAM 83.

In Step S20, the CPU 81 judges whether or not the results of the games have been received from the control unit 13. Here, when a negative result is obtained, this stands for that the games are not ended yet, and the CPU 81 repeats the processing of Step S20 until receiving the results of the games.

Then, when the results of the games are transmitted from the control unit 13 to the terminal 15, the CPU 81 obtains a positive result in Step S20, thereby proceeding from Step S20 to Step S21.

In Step S21, among game result reception flags stored in a game result reception flag storage area 83G of the RAM 83, the CPU 81 rewrites the flags, which corresponds to the games (the horse race game and the roulette game) and has been received in Step S20 described above, from “0” to “1”. For example, in the case of having received the game result (the magnitude of the award generated for the terminal 15) of the horse race game in Step S20 described above, the CPU 81 rewrites, to “1”, the game result reception flag associated with the horse race game.

As described above, in the case of having received the results of the games from the control unit 13, the CPU 81 changes the received game result reception flags corresponding to the games, thus making it possible to judge whether or not both of the horse race game and the roulette game have been ended based on the states of the flags.

In Step S22, the CPU 81 displays the magnitudes of the awards (that is, the payouts), which are generated for the terminal 15, on the first and second windows 101 and 102 (FIG. 14, FIG. 15) of the image display device 88 thereof. Specifically, the CPU 81 displays the magnitude of the award, which is related to the horse race game, on the last-game display region 107 of the first window 101 shown in FIG. 14. In the display example shown in FIG. 14, the magnitude of the award acquired by the terminal 15 concerned in the horse race game was 15 medals, whereby “WIN 15” is displayed. Moreover, the CPU 81 displays the magnitude of the award, which is related to the roulette game, on the last-game display region 125 of the second window 102 shown in FIG. 15. In the display example shown in FIG. 15, the magnitude of the award acquired by the terminal 15 concerned in the roulette game was 72 medals, whereby “WIN 72” is displayed.

Moreover, the terminal 15 receives the number of credits, which has been updated in the RAM 23 of the control unit 13, together with the results of the games. In Step S23, the CPU 81 updates the number of credits in the RAM 83, and displays the updated number of credits on the number-of-credits display region 131 (FIG. 13).

Moreover, the CPU 81 calculates the accumulated value of the magnitudes of the awards for the horse race games and the accumulated value of the magnitudes of the awards for the roulette game, both of which are generated for the terminal 15. Then, the CPU 81 stores the accumulated values thus calculated in the payout accumulated value storage area 83E of the RAM 83, and displays both of the accumulated values concerned on the total number-of-payouts display regions 108 and 129 of the first and second windows 101 and 102, respectively.

In Step S24, the CPU 81 judges whether or not both of the horse race game and the roulette game have been ended. Specifically, upon having received, from the control unit 13, a message that both of the games have been ended, the CPU 81 judges whether or not to have received the results of the games of both of the horse race game and the roulette game with reference to the game result reception flags in the RAM 83. In the case of not having received the results of both of the games, the CPU 81 obtains a negative result, thereby returning to Step S20 described above. On the contrary, in the case of having received the results of both of the games, the CPU 81 obtains a positive result in Step S24, thereby proceeding to Step S25. In Step S25, the CPU 81 resets the game result reception flags from “1” to “0”. Thereafter, the CPU 81 returns to Step S11 described above, and repeats similar processing.

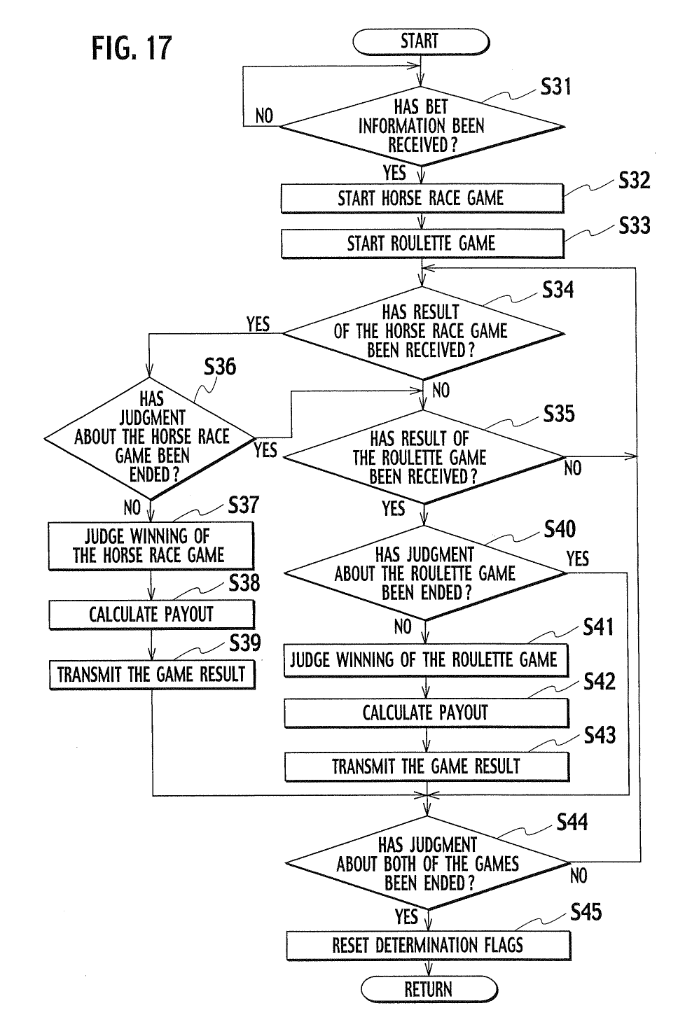

Next, FIG. 17 shows a series of operations from the reception of the bet information to the transmission of the results of the games in the control unit 13. Note that, in FIG. 17, the step of receiving the information regarding the number of credits, which is transmitted from each of the terminals 15 based on the insertion of the medals, is omitted; however, this processing is performed at any time. Upon receiving this information, the CPU 21 updates the number of credits, which is stored in the RAM 23.

As shown in FIG. 17, in Step S31, the CPU 21 of the control unit 13 judges whether or not to have received the bet information from the terminal 15. When a negative result is obtained, this stands for that the betting period has not elapsed in the terminal 15, and the CPU 21 repeats the processing of Step S31 until receiving the bet information. Note that, even if there is no input of the bet for the game, each of the terminals 15 transmits the bet information (information indicating that the number of bets is “0”) to the control unit 13. When the bet information is transmitted to the control unit 13 from all of the terminals 15, the CPU 21 obtains a positive result in Step S31, thereby proceeding from Step S31 to Step S32.

In Step S32, the CPU 21 transmits a signal, which instructs the start of the horse race game, to the horse race gaming machine 11, and allows the horse race gaming machine 11 to start the horse race game. In Step S33, the CPU 21 transmits a signal, which instructs the start of the roulette game, to the roulette gaming machine 12, and allows the roulette gaming machine 12 to start the roulette game.

Then, the CPU 21 waits for receiving the results of the games from the horse race gaming machine 11 and the roulette gaming machine 12.

In Step S34, the CPU 21 judges whether or not to have received the result of the horse race game from the horse race gaming machine 11. When a negative result is obtained in Step S34, this stands for that the horse race game has not been ended. Then, the CPU 21 proceeds to subsequent Step S35, and judges whether or not to have received the result of the roulette game from the roulette gaming machine 12. When a negative result is obtained in Step S35, this stands for that any of the horse race game and the roulette game has not been ended. Then, the CPU 21 returns from Step S35 to Step S34 described above, and repeats similar processing.

On the contrary, when a positive result is obtained in Step S34, this stands for that the horse race game has been ended. Then, the CPU 21 proceeds from Step S34 to Step S36, and judges whether or not the winning result has already been judged for the horse race game. In the case of this embodiment, the control unit 13 judges the winning results regarding the horse race game and the roulette game in each of the terminals every time when each of the games is executed. Then, the control unit 13 stores results of the judgments (that is, the number of payouts to each of the terminals 15) in the number-of-payouts storage area 23C of the RAM 23, and rewrites the judgment flag regarding the horse race game in the judgment flag storage area 23E of the RAM 23 from “0” to “1”, thereby recording, in the RAM 23, that the judgment as to whether the horse race game has been won has been ended. In such a way, the CPU 21 judges whether or not the judgment as to whether the horse race game has been won has been ended based on the above-described judgment flag.

When a negative result is obtained in Step S36, this stands for that the winning result of the horse race game is not obtained. The CPU 21 proceeds from Step S36 to S37, and judges whether or not the horse race game has been won based on the bet information of the terminal 15 in the horse race game and on the result of the game concerned. The bet information is stored in the bet information storage area 23A of the RAM 23, which is shown in FIG. 5.

Then, the CPU 21 proceeds to Step S38, and calculates the payout (the number of paid out medals) to the terminal 15 based on the winning result. In Step S39, the CPU 21 transmits the payout (the result of the game) to the corresponding terminal 15. Then, the CPU 21 proceeds from Step S39 to Step S44.

On the contrary, when a positive result is obtained in Step S36, this stands for that the judgment as to whether the horse race game has been won has been ended. The CPU 21 proceeds from Step S36 to Step S35, and judges whether or not to have received the result of the roulette game from the roulette gaming machine 12.

When a positive result is obtained in Step S35, this stands for that the roulette game has been ended. The CPU 21 proceeds from Step S35 to Step S40, and judges whether or not the winning result has already been judged for the roulette game. The CPU 21 judges whether or not the winning result has already been judged for the roulette game based on the determination flag regarding the roulette game, which is stored in the judgment flag storage area 23E of the RAM 23.

When a negative result is obtained in Step S40, this stands for that the winning result of the roulette game is not obtained. The CPU 21 proceeds from Step S40 to Step S41, and judges whether or not the roulette game has been won based on the bet information of the terminal 15 in the roulette game and on the result of the game concerned. The bet information is stored in the bet information storage area 23A of the RAM 23, which is shown in FIG. 5.

Then, the CPU 21 proceeds to Step S42, and calculates the payout (the number of paid out medals) to the terminal 15 based on the winning result. In Step S43, the CPU 21 transmits the payout (the result of the game) to the corresponding terminal 15.

Meanwhile, when a positive result is obtained in Step S40, this stands for that the winning result of the roulette game has already been obtained. Then, the CPU 21 proceeds from Step S40 to S44.

In Step S44, the CPU 21 judges whether or not the judgment as to whether both of the horse race game and the roulette game have been won has been ended based on information on the number of payouts as the game results of the horse race game and the roulette game, which are stored in the number-of-payouts storage area 23C of the RAM 23. When a negative result is obtained in Step S44, this stands for that the winning results of both of the horse race game and the roulette game have not been judged. The CPU 21 proceeds from Step S44 to Step S34 described above, and repeats similar processing.

On the contrary, when a positive result is obtained in Step S44, this stands for that the winning results of both of the horse race game and the roulette game has already been judged. The CPU 21 proceeds from Step S44 to Step S45, and resets the determination flags in the judgment flag storage area 23E of the RAM 23, thereby preparing for the next games. Then, for the next games, the CPU 21 repeats similar processing to that from Step S31 described above.

As described above, in the game apparatus 10, when both of the horse race game and the roulette game are ended, the reception of the bets is started in the terminal 15. Specifically, a control is made so that the reception period for the bet on the horse race game and the reception period for the bet on the roulette game can overlap each other.

When the reception of the bets is started, the bet screen shown in FIG. 13 is displayed on the image display device 88 of the terminal 15. On the bet screen, the first window 101 for receiving the bet on the horse race game and the second window 102 for receiving the bet on the roulette game are displayed simultaneously.

When the first window 101 is operated, the CPU 81 receives a result of the operation as the bet on the horse race game. When the second window 102 is operated, the CPU 81 receives a result of the operation as the bet on the roulette game. As described above, as the results of the operations of the first and second windows 101 and 102 displayed simultaneously, the bets on these two games are received.

In such a way, the player is given an opportunity to simultaneously participate in both of the horse race game and the roulette game.

Moreover, when the receptions of the bets on the horse race game and the roulette game are ended, the bet information on these games is transmitted from the terminal 15 to the control unit 13, and the horse race game and the roulette game are started simultaneously. The horse race game and the roulette game are started simultaneously as described above, whereby a difference between points of time when the horse race game and the roulette game are ended depends only on a difference between the contents of the respective games. Accordingly, it becomes possible for the reception period for the bet on the horse race game and the reception period for the bet on the roulette game to easily overlap each other.

In the above-described embodiment, the description has been made of the case of simultaneously starting the horse race game and the roulette game; however, the present invention is not limited to this. For example, such a configuration may be adopted, in which one of the games is first started, the other game is started after the preceding game is ended, and when these games are ended, the terminal 15 receives the bets on both of the games.

In such a way, the player can sequentially watch the progress of the two games on which the player has made the bets simultaneously.

Moreover, in the above-described embodiment, the description has been made of the case of simultaneously starting the horse race game and the roulette game after the betting period for the horse race game and the roulette game is ended; however, the present invention is not limited to this. For example, such a configuration may be adopted, in which either one of the horse race game and the roulette game is first started after the betting period for the horse race game and the roulette game is ended, and the other game is started after the preceding game is ended. In such a way, the player is given time for concentrating on individually watching the horse race game and the roulette game.

Moreover, in the above-described embodiment, the description has been made of the case of changing the blink cycle of the display frames 201 and 202 in response to the remaining time of the betting period; however, the present invention is not limited to this. For example, a display color of the display frames 201 and 202 or the display regions may be changed. In this case, there can be used a method of changing the display color from a bright color to a dark color or gradually deepening the display color as the remaining time is being reduced.

Moreover, in the above-described embodiment, the description has been made of the case where the bet screen is displayed on the image display device 88, and the player operates the touch panel provided on the surface of the screen; however, the present invention is not limited to this. For example, a mechanical switch such as a button switch may be used for inputting the bet. In this case, a configuration can be adopted, in which a lamp is provided on a part or periphery of the switch, and the lamp is made to blink or to turn on when there comes a state of receiving the bet.

Moreover, in the above-described embodiment, the description has been made of the case of progressing the games by using actual substances as the horse race gaming machine 11 that allows the model horses 55 to run, and as the roulette gaming machine 12 that launches the ball 78 onto the roulette wheel 71; however, the present invention is not limited to this. For example, there may be used gaming machines, on each of which the progress of the game is shown by a displayed image, such as gaming machines, in each of which an image of the game is displayed on a display screen of a liquid crystal display device or the like and the game is progressed by a motion of the image.

Moreover, in the above-described embodiment, the description has been made of the game apparatus including the horse race game and the roulette game; however, the present invention is not limited to this. The present invention can be applied to the case where the player participates in a plurality of other various games such as a card game. Furthermore, the number of games is not limited to two, and the present invention can also be applied to the case where the player participates in three or more games.

### Second Embodiment

A second embodiment is different from the first embodiment in a display mode on the screen for receiving the bet, which is displayed on the image display device 88 of the terminal 15. A game apparatus according to the second embodiment has similar configurations to those of the game apparatus 10 of the first embodiment except a configuration related to the display of the bet screen. In the following description, the same reference numerals are assigned to the same portions as those of the first embodiment, and a duplicate description is omitted.

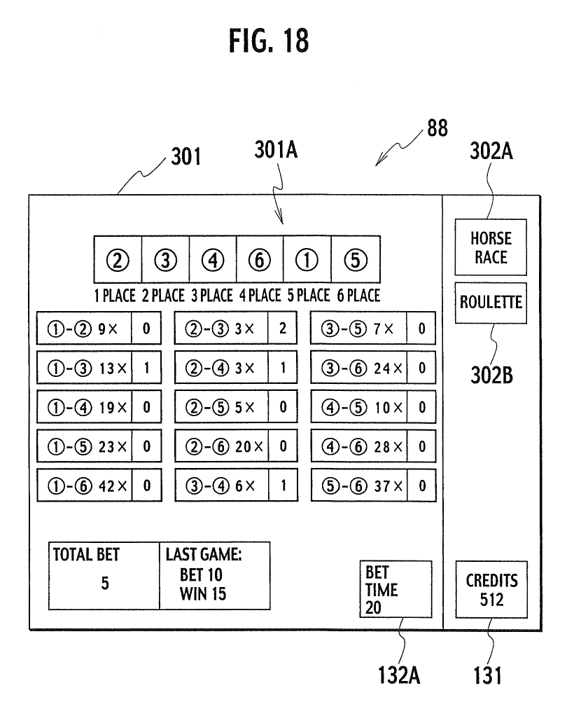

As shown in FIG. 18, in the game apparatus of this embodiment, the terminal 15 (FIG. 11) displays a bet screen on the image display device 88. On this bet screen, there are displayed a first window 301, first and second switching switches 302A and 302B, and the number-of-credits display region 131.

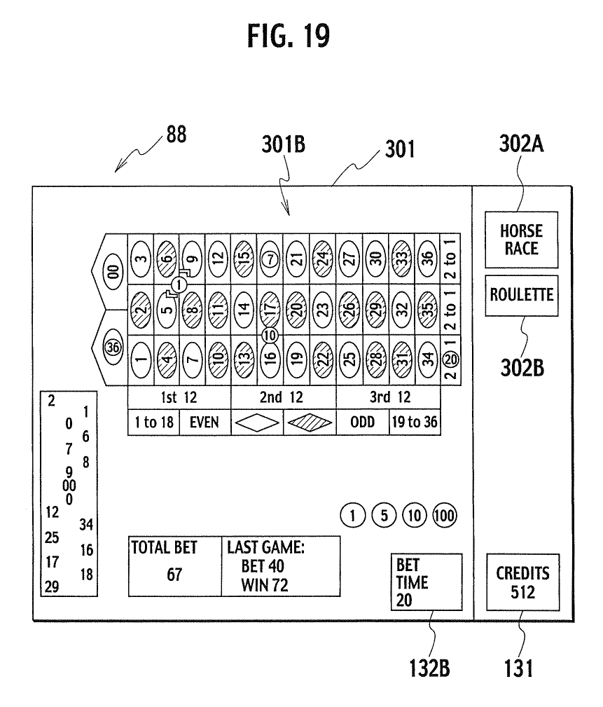

The first and second switching switches 302A and 302B are switches for switching the contents displayed on the window 301. When images of the first and second switching switches 302A and 302B are operated to be pressed, a result of the operation is outputted from the touch panel 92 provided on the surface of the bet screen. When the first switching switch 302A is operated, as shown in FIG. 18, the CPU 81 (FIG. 11) of the terminal 15 displays, on the window 301, a reception screen 301A for the bet on the horse race game. When the second switching switch 302B is operated, as shown in FIG. 19, the CPU 81 displays, on the window 301, a reception screen 301B for the bet on the roulette game. When it becomes possible to make the bets on both of the horse race game and the roulette game, the first and second switching switches 302A and 302B start to blink simultaneously, and the bet screen on the game corresponding to the switch operated in this state is displayed on the image display device 88.

The number-of-credits display region 131 is a region that displays the number of credits owned by the terminal 15 (that is, the player). The displayed number of credits is changed in response to the number of credits owned by the terminal 15 when the bet input is performed, the payout is provided based on the result of the game, and so on.

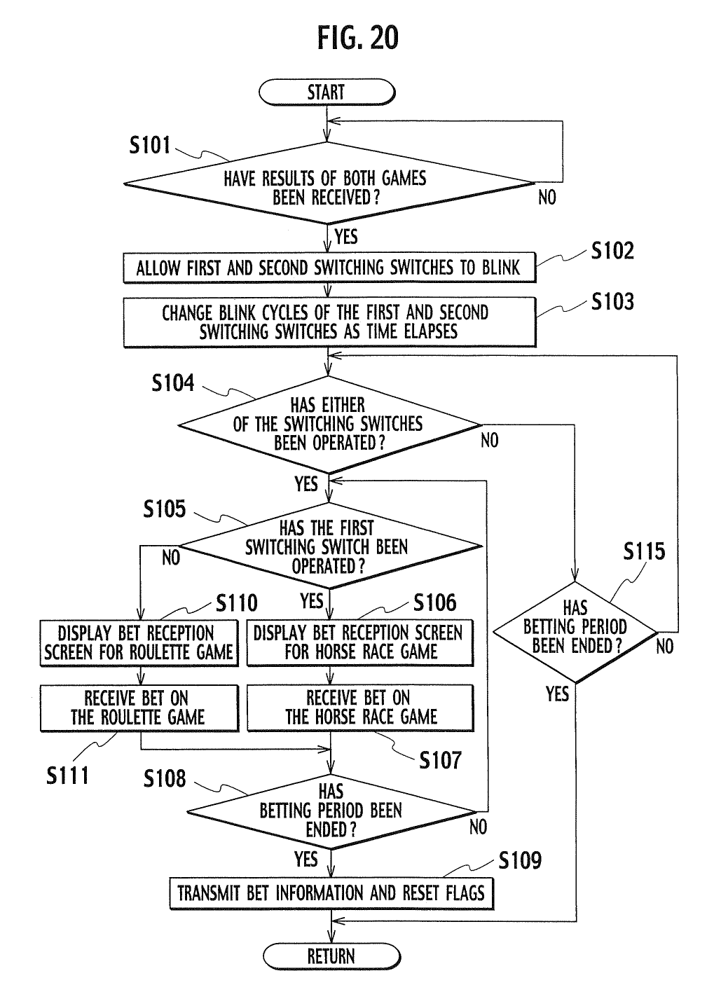

FIG. 20 is a flowchart showing processing related to the switching of the bet screen by the CPU 81. As shown in FIG. 20, in Step S101, the CPU 81 judges whether or not to have already received the game result of the horse race game and the game result of the roulette game from the control unit 13 (FIG. 3). This judgment is performed based on the game result reception flags of the RAM 83 (FIG. 11). When both of the results of the games have not been received yet, the CPU 81 obtains a negative result in Step S101, thereby repeating the processing of Step S101 until the reception of both of the results of the games is completed. On the contrary, when the game result of the horse race game and the game result of the roulette game have already been received, the CPU 81 obtains a positive result in Step S101, thereby proceeding from Step S101 to Step S102, and allowing the first switching switch 302A (FIG. 18, FIG. 19) and the second switching switch 302B (FIG. 18, FIG. 19) to blink. As described above, when the respective game results of the horse race game and the roulette game have been received, and it becomes possible to receive the bets on both of the games, the switching switch 302A for selecting the bet reception screen for the horse race game and the switching switch 302B for selecting the bet reception screen for the roulette game blink. In such a way, the player is notified that it has become possible to receive the bets on the next horse race game and the next roulette game.

Then, the CPU 81 proceeds to Step S103, and changes a blink cycle of the first switching switch 302A and a blink cycle of the second switching switch 302B as the time elapses. For example, after the reception of both of the results of the games is completed, the CPU 81 activates the internal timer, and as counting thereof progresses, shortens the blink cycles of the first switching switch 302A and the second switching switch 302B. As described above, the blinks of the first switching switch 302A and the second switching switch 302B become faster, whereby the player is visually notified that the end of the bet reception will come soon.

In Step S104, the CPU 81 judges whether or not the first switching switch 302A or the second switching switch 302B has been operated in this state. When a negative result is obtained in Step S104, this stands for that any of the first switching switch 302A and the second switching switch 302B is not operated. The CPU 81 proceeds from Step S104 to Step S115, and judges whether or not the betting period has been ended based on the result of the counting of the internal timer.

When a negative result is obtained in Step S115, the CPU 81 returns to Step S104 described above, and repeats the above-described judgment. On the contrary, when a positive result is obtained in Step S115, this sands for that the betting period has been ended. The CPU 81 returns to Step S101 described above, and waits for the start of the next betting period.

Meanwhile, when a positive result is obtained in Step S104, this stands for that the first or second switching switch 302A or 302B has been operated. The CPU 81 proceeds from Step S104 to Step S105, and judges whether or not the operated switch is the first switching switch 302A.

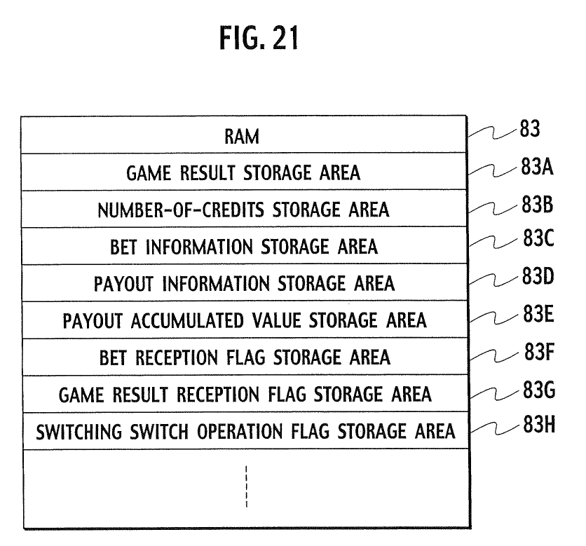

When a positive result is obtained in Step S105, this stands for that the first switching switch 302A has been operated. The CPU 81 proceeds from Step S105 to Step S106, and displays the bet reception screen for the horse race game on the first window 301 (FIG. 18). Note that, when the first switching switch 302A has been operated in Step S104 described above, a flag associated with the first switching switch 302A, which is stored in a switching switch operation flag storage area 83H of the RAM 83 shown in FIG. 21, is rewritten to “1”, and a flag associated with the second switching switch 302B, which is stored therein, is rewritten to “0”. Meanwhile, when the second switching switch 302B has been operated, the flag associated with the second switching switch 302B, which is stored in the switching switch operation flag storage area 83H, is rewritten to “1”, and the flag associated with the first switching switch 302A, which is stored therein, is rewritten to “0”.

Then, the CPU 81 proceeds to Step S107, and starts to receive the bet on the horse race game. The contents of the bet (that is, the bet information) are stored in the bet information storage area 83C (FIG. 21) of the RAM 83.

Then, in Step S108, the CPU 81 judges whether or not the reception period for the bet has been ended based on the result of the counting of the internal timer. When a positive result is obtained, this stands for that the result of the counting of the internal timer has reached a result of counting, which is preset as the betting period. Then, the CPU 81 proceeds from Step S108 to Step S109, reads out the bet information regarding the horse race game and the roulette game from the bet information storage area 83C of the RAM 83, and transmits the read-out bet information to the control unit 13. Note that, when the bet is made only on the horse race game during the betting period, the bet information on the horse race game is stored in the bet information storage area 83C. Moreover, in Step S109, the CPU 81 individually rewrites (resets), from “1” to “0”, a flag corresponding to the horse race game and a flag corresponding to the roulette game. Here, the flags are stored in the game result reception flag storage area 83G (FIG. 21). In addition, the CPU 81 rewrites (resets), from “1” to “0”, the flag related to the first switching switch 302A and the flag related to the second switching switch 302B. Here, the flags are stored in the switching switch operation flag storage area 83H. In such a way, the CPU 81 prepares for the reception of the next game results. Note that, when only the first switching switch 302A has been operated in this case, only the flag corresponding to the first switching switch 302A has been “1”, and only this flag is rewritten to

Meanwhile, when a negative result is obtained in Step S108, this stands for that the betting period has not been ended. The CPU 81 returns from Step S108 to Step S105, and repeats similar processing. Note that, when the bet is being made on the horse race game, in the case where the CPU 81 returns from Step S108 to Step S105, and in the case where the second switching switch 302B is not operated, the flag related to the first switching switch 302A, which is stored in the switching switch operation flag storage area 83H, has been “1”. From this, the CPU 81 obtains the positive result in Step S105, whereby the CPU 81 proceeds from Step S105 to Step S106, and continues to receive the bet on the horse race game.

Meanwhile, when a negative result is obtained in Step S105, this stands for that the second switching switch 302B has been operated. The CPU 81 proceeds from Step S105 to Step S110, and displays the bet reception screen for the roulette game on the window 301 (FIG. 19).

Then, the CPU 81 proceeds to Step S111, and starts to receive the bet on the roulette game. The contents of the bet (that is, the bet information) are stored in the bet information storage area 83C (FIG. 21) of the RAM 83.

Then, in Step S108, the CPU 81 judges whether or not the reception period for the bet has been ended based on the result of the counting of the internal timer. When the positive result is obtained, this stands for that the result of the counting of the internal timer has reached the result of the counting, which is preset as the betting period. The CPU 81 proceeds from Step S108 to Step S109, reads out the bet information regarding the horse race game and the roulette game from the bet information storage area 83C of the RAM 83, and transmits the read-out bet information to the control unit 13. Note that, when the bet is made only on the roulette game during the betting period, the bet information on the roulette game is stored in the bet information storage area 83C. Moreover, in Step S109, the CPU 81 individually rewrites (resets), from “1” to “0”, the flag corresponding to the horse race game and the flag corresponding to the roulette game. Here, the flags are stored in the game result reception flag storage area 83G (FIG. 21). In addition, the CPU 81 rewrites (resets), from “1” to “0”, the flag related to the first switching switch 302A and the flag related to the second switching switch 302B. Here, the flags are stored in the switching switch operation flag storage area 83H. In such a way, the CPU 81 prepares for the reception of the next game results. Note that, when only the second switching switch 302B has been operated in this case, only the flag corresponding to the second switching switch 302B has been “1”, and only this flag is rewritten to “0”.

Meanwhile, when the negative result is obtained in Step S108, this stands for that the betting period has not been ended. The CPU 81 returns from Step S108 to Step S105, and repeats similar processing. Note that, when the bet is being made on the roulette game, in the case where the CPU 81 returns from Step S108 to Step S105, and in the case where the first switching switch 302A is not operated, the flag related to the second switching switch 302B, which is stored in the switching switch operation flag storage area 83H, has been “1”. From this, the CPU 81 obtains the negative result in Step S105, whereby the CPU 81 proceeds from Step S105 to Step S110, and continues to receive the bet on the roulette game.

As described above, in the game machine according to the second embodiment, after both of the horse race game and the roulette game are ended, the reception of the bets on both of the horse race game and the roulette game is started.

In the betting period while such bet reception is being performed, the screen for receiving the bet on the horse race game and the screen for receiving the bet on the roulette game are displayed while being switched by the operations of the switches (the first and second switching switches 302A and 302B), and the bet reception is performed on each of the screens.

As described above, in a state where the period for receiving the bet on the horse race game and the period for receiving the bet on the roulette game overlap each other, the bet reception for the horse race game and the bet reception for the roulette game are performed by switching the screens. From this, during this betting period, the player is given an opportunity to participate in both of the games. Moreover, the betting period for the horse race game and the roulette game is executed after both of the horse race game and the roulette game are ended, and the horse race game and the roulette game are started after the end of the betting period, whereby the player is given time for concentrating on the betting operations.

In the above-described embodiment, the description has been made of the case of simultaneously starting the horse race game and the roulette game after the betting period for the horse race game and the roulette game is ended; however, the present invention is not limited to this. For example, such a configuration may be adopted, in which either one of the horse race game and the roulette game is first started after the betting period for the horse race game and the roulette game is ended, and the other game is started after the preceding game is ended. In such a way, the player is given the time for concentrating on individually watching the horse race game and the roulette game.

Moreover, in the above-described embodiment, the description has been made of the case, when it has become possible to make the bet, the corresponding switching switch (the first or second switching switch 302A or 302B) is made to blink; however, the present invention is not limited to this. For example, these switching switches may be adapted to turn on. In this case, a color or brightness when the switching switches turn on may be adapted to change in response to the remaining time of the betting period.

Moreover, in the above-described embodiment, the description has been made of the case where the bet screen is displayed on the image display device 88, and the player operates the touch panel provided on the surface of the screen; however, the present invention is not limited to this. For example, a mechanical switch such as a button switch may be used. In the case of using such mechanical switches as the first and second switching switches 302A and 302B, a configuration can be adopted, in which a lamp is provided on a part or periphery of each of the switches, and the lamp is made to blink when there comes a state of receiving the bet.

Moreover, in the above-described embodiment, the description has been made of the case of progressing the games by using actual substances as the horse race gaming machine 11 that allows the model horses 55 to run, and as the roulette gaming machine 12 that launches the ball 78 onto the roulette wheel 71; however, the present invention is not limited to this. For example, there may be used gaming machines, on each of which the progress of the game is shown by a displayed image, such as gaming machines, in each of which an image of the game is displayed on a display screen of a liquid crystal display device or the like and the game is progressed by a motion of the image.

Moreover, in the above-described embodiment, the description has been made of the game apparatus including the horse race game and the roulette game; however, the present invention is not limited to this. The present invention can be applied to the case where the player participates in a plurality of other various games such as a card game. Furthermore, the number of games is not limited to two, and the present invention can also be applied to the case where the player participates in three or more games.

### Third Embodiment

A third embodiment is different from the first embodiment in receiving in advance the bets on the horse race game and the roulette game. A game apparatus according to the third embodiment has similar configurations to those of the game apparatus 10 of the first embodiment except a configuration related to the bet reception processing. In the following description, the same reference numerals are assigned to the same portions as those of the first embodiment, and a duplicate description is omitted.

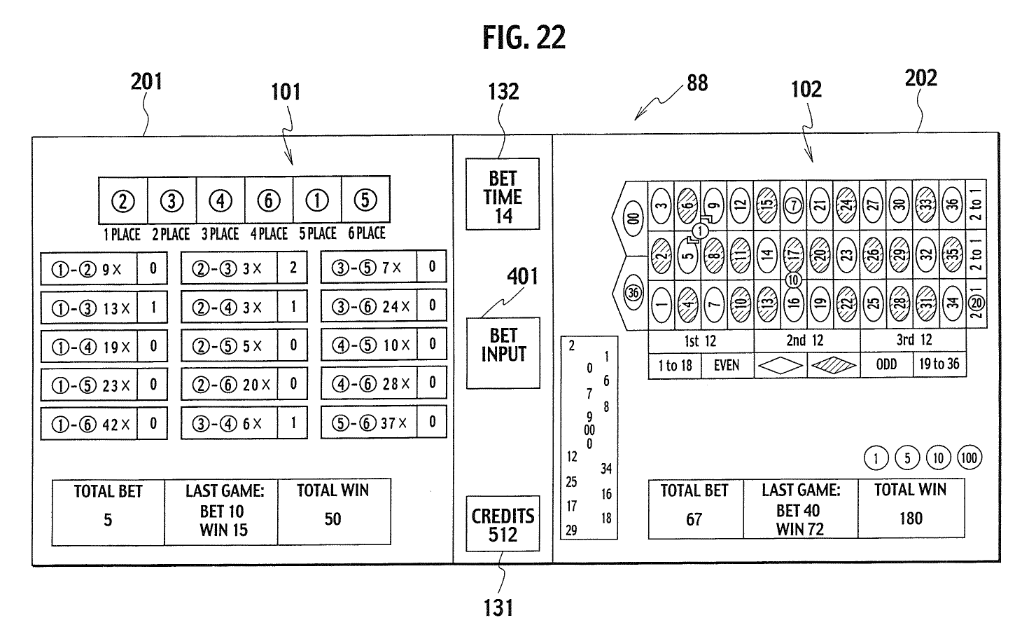

As shown in FIG. 22, in the game apparatus of this embodiment, on the bet screen displayed on the image display device 88 of the terminal 15 (FIG. 11), a bet input button 401 is provided between the first window 101 and the second window 102.

This bet input button 401 is a button for receiving the bets regardless of the betting period set from the end of the game to the start of the next games. When the touch panel 92 provided on a surface of an image of the bet input button 401 is operated to be pressed, a result of the operation is outputted to the CPU 81 of the terminal control unit 80 (FIG. 11). The CPU 81 that has received the result of the operation starts to receive the bets no matter whether or not such bet reception may be performed during the betting period.

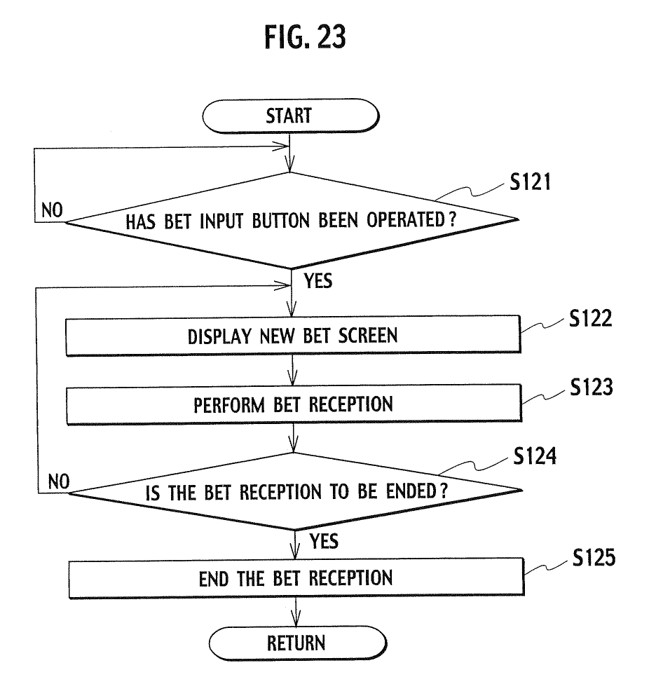

FIG. 23 is a flowchart showing the bet reception processing always executed by the CPU 81 of the terminal 15. This processing is processing executed by the CPU 81 separately from the series of processing from the bet reception to the payout of the award in the terminal 15. The above-described series of processing is shown in FIG. 16, and the bet reception processing of FIG. 23 is always executed when the series of processing in FIG. 16 is executed.

As shown in FIG. 23, in Step S121, the CPU 81 judges whether or not the bet input button 401 (FIG. 22) has been operated. When a negative result is obtained in Step S121, this stands for that the bet input button 401 is not operated, and the CPU 81 repeats Step S121.

On the contrary, when the bet input button 401 has been operated, a positive result is obtained in Step S121, whereby the CPU 81 activates the internal timer, and then proceeds to subsequent Step S122. In Step S122, the CPU 81 displays a new bet screen. The new bet screen stands for a bet screen displayed in a manner of being switched from the bet screen displayed until the bet input button 401 is operated. Contents of the bet screen are similar to those of the bet screen for the horse race game, which is shown in FIG. 14, and to those of the bet screen for the roulette game, which is shown in FIG. 15.

This new bet screen is displayed on the image display device 88, whereby the player is given an opportunity to input the bets on the horse race game and the roulette game even if the horse race game and the roulette game are under execution.

In Step S123, the CPU 81 receives the bets inputted through the new bet screen. The CPU 81 stores contents of the received bets as the bet information in the bet information storage area 83C of the RAM 83.

In Step S124, the CPU 81 judges whether or not to end the reception of the bets based on a result of the counting of the internal timer. When a negative result is obtained in Step S124, this stands for that a preset time has not elapsed. The CPU 81 returns from Step S124 to Step S122 described above, and continues to receive the bets. On the contrary, when a positive result is obtained in Step S124, this stands for that the preset time has elapsed. Then, in Step S125, the CPU 81 ends the reception of the bets, and returns the image displayed on the image display device 88 to the image displayed before the processing of Step S122 described above is executed. Thereafter, the CPU 81 returns to Step S121 described above, and repeats similar processing.

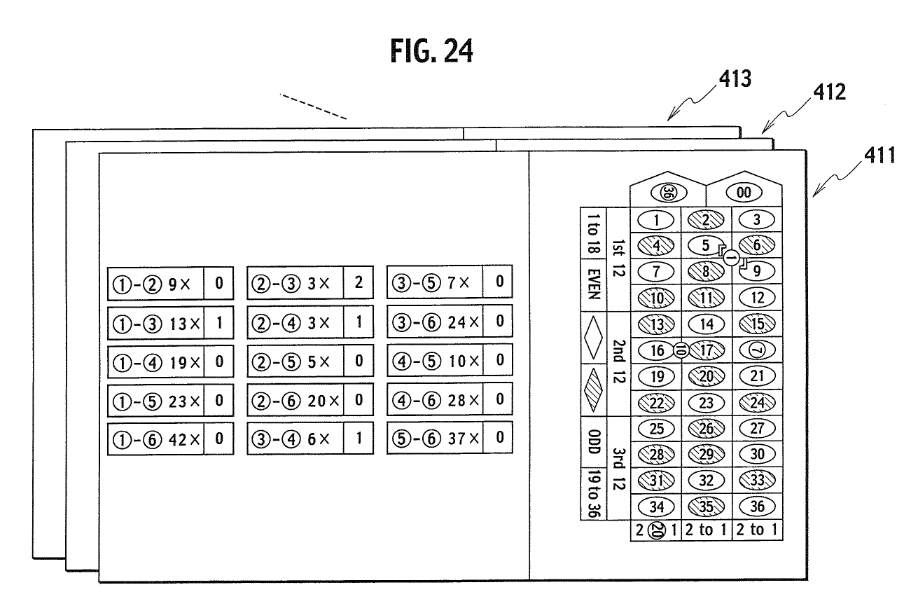

As described above, the CPU 81 always executes the bet reception processing shown in FIG. 23 even if the processing shown in FIG. 16 is under execution. In such a way, the bet information on the games which are not executed yet is stored in the bet information storage area 83C of the RAM 83. Every time when the bet input button 401 is operated, the CPU 81 obtains the positive result in Step S121 shown in FIG. 23, thereby receiving new bet information, and storing the received new bet information in the bet information storage area 83C of the RAM 83. In such a way, as shown in FIG. 24, in the bet information storage area 83C of the RAM 83, a plurality of the bet information 411, 412, 413 . . . are stored in order of the inputs. The input orders are individually added to the respective pieces of bet information 411, 412, 413 . . . . Each piece of the bet information 411, 412, 413 is a combination of the bet on the horse race game and the bet on the roulette game.

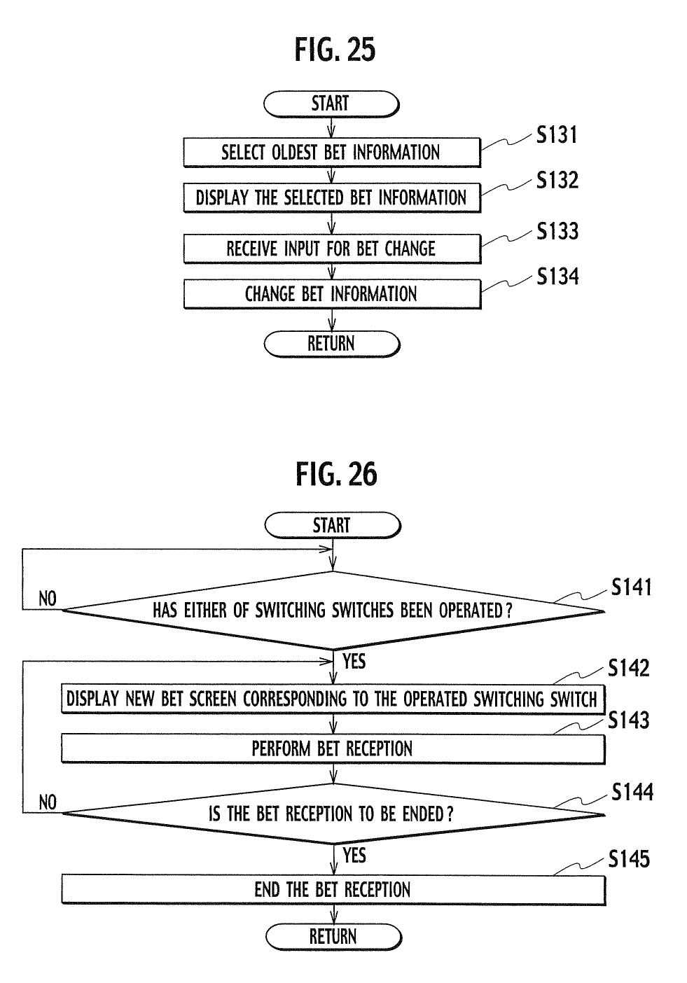

FIG. 25 is a flowchart showing a procedure of the bet reception processing by the CPU 81. This processing is processing according to this embodiment, which is executed in Step S16 shown in FIG. 16. As other processing in the terminal 15, the processing shown in FIG. 16 is executed.

When the CPU 81 starts to receive the bets by obtaining the positive result in Step S15 of FIG. 16, the CPU 81 proceeds to Step S131 shown in FIG. 25. In Step S131, the CPU 81 reads out the oldest information from among the plurality of bet information stored in the bet information storage area 83C of the RAM 83 by the processing shown in FIG. 23. In Step S132, the CPU 81 displays the oldest information on the image display device 88. In such a way, the player is informed of the contents of the bets on the next games.

In Step S133, the CPU 81 receives an input for changing the bets through the bet screen displayed in Step S132 described above. When such a bet input operation is performed for the bet screen, the CPU 81 judges that the contents of the bets have been changed. In Step S134, the CPU 81 changes the bet information, which is stored in the bet information storage area 83C, in response to contents of the bets inputted in Step S133. Then, the CPU 81 proceeds to Step S17 of FIG. 16.

When the betting period is ended, the CPU 81 obtains the positive result in Step S17 (FIG. 16), thereby proceeding to Step S18 (FIG. 16). In Step S18, the CPU 81 finishes receiving the bets. In Step S19 (FIG. 16), the CPU 81 reads out, from the RAM 83, the bet information selected in Step S131 (FIG. 25) described above and updated in Step S134 (FIG. 25) described above, and transmits the bet information to the control unit 13.

As described above, the terminal 15 of the game apparatus according to this embodiment receives the inputs of the bets at any time regardless of the progress of the games. The contents of the inputted bets are accumulated in the bet information storage area 83C of the RAM 83.

Then, during the betting period after the horse race game and the roulette game are ended, the oldest information is read out from among the plurality of bet information accumulated in the RAM 83, and is displayed on the image display device 88. In such a way, the player is given an opportunity to change the bet information.

Then, the betting period is ended after the elapse of a fixed time, and the bet information, which the player is given the opportunity to change, is transmitted to the control unit 13.

From the above, the player is always given an opportunity to input the bets regardless of the progress of the games.

Note that, in the above-described embodiment, the description has been made of the case of giving the player the opportunity to change the bet information pre-stored in the RAM 83; however, the present invention is not limited to this. For example, the bet information stored in the RAM 83 may be adapted to be transmitted without displaying the bet screen in Step S132.

Moreover, in the above-described embodiment, the description has been made of the case where the betting period is started after the horse race game and the roulette game are ended, and the bet information is transmitted from the terminal 15 to the control unit 13 during the betting period; however, the present invention is not limited to this. For example, such a configuration may be adopted, in which the bet information regarding the horse race game is transmitted from the terminal 15 to the control unit 13 after the horse race game is ended, and the bet information regarding the roulette game is transmitted from the terminal 15 to the control unit 13 after the roulette game is ended. Moreover, a configuration may be adopted, in which, regardless of the progress of the games, when the bets are received in Step S123 (FIG. 23), the received bet information is transmitted from the terminal 15 to the control unit 13 every time when the bet information is received, and is stored in the RAM 23 of the control unit 13.

Moreover, in the above-described embodiment, the description has been made of the case of simultaneously starting the horse race game and the roulette game after the betting period for the horse race game and the roulette game is ended; however, the present invention is not limited to this. For example, such a configuration may be adopted, in which either one of the horse race game and the roulette game is first started after the betting period for the horse race game and the roulette game is ended, and the other game is started after the preceding game is ended. In such a way, the player is given time for concentrating on individually watching the horse race game and the roulette game.

Moreover, in the above-described embodiment, the description has been made of the case where the first widow 101 and the second window 102 are simultaneously displayed on the image display device 88; however, the present invention is not limited to this. For example, as described with reference to FIG. 18 to FIG. 20, the present invention can also be applied to the case of selecting and displaying either one of the first window 101 and the second window 102. In this case, the CPU 81 always executes bet reception processing shown in FIG. 26 separately from the series of processing, shown in FIG. 20, from the bet reception processing to the payout of the award.

Specifically, as shown in FIG. 26, in Step S141, the CPU 81 judges whether or not either one of the first and second switching switch 302A and 302B (FIG. 18, FIG. 19) has been operated. When a negative result is obtained in Step S141, this stands for that any of the switching switches 302A and 302B has not been operated, and the CPU 81 repeats Step S141.

On the contrary, when either of the first switching switch 302A and the second switching switch 302B has been operated, the CPU 81 obtains a positive result in Step S141. In such a way, the CPU 81 activates the internal timer, and proceeds to subsequent Step S142. In Step S142, the CPU 81 displays a new bet screen (a bet screen for the horse race game or a bet screen for the roulette game) corresponding to the operated switching switch 302A or 302B. The new bet screen stands for a bet screen displayed in a manner of being switched from the bet screen displayed until the switching switch 302A or 302B is operated. Contents of the bet screen are similar to those of the bet screen for the horse race game, which is shown in FIG. 18, or to those of the bet screen for the roulette game, which is shown in FIG. 19.

This new bet screen is displayed on the image display device 88, whereby the player is given an opportunity to input the bet on the horse race game or the roulette game even if the horse race game or the roulette game is under execution.

In Step S143, the CPU 81 receives the bet inputted through the new bet screen. The CPU 81 stores contents of the received bet as the bet information in the bet information storage area 83C of the RAM 83.

In Step S144, the CPU 81 judges whether or not to end the reception of the bets based on a result of the counting of the internal timer. When a negative result is obtained in Step S144, this stands for that a preset time has not elapsed. The CPU 81 returns from Step S144 to Step S142 described above, and continues to receive the bets. On the contrary, when a positive result is obtained in Step S144, this stands for that the preset time has elapsed. Then, in Step S145, the CPU 81 ends the reception of the bets, and returns the image displayed on the image display device 88 to the image displayed before the processing of Step S142 described above is executed. Thereafter, the CPU 81 returns to Step S141 described above, and repeats similar processing.

As described above, the CPU 81 always executes the bet reception processing shown in FIG. 26 even if the processing shown in FIG. 20 is under execution. In such a way, the bet information on the games which are not executed yet is stored in the bet information storage area 83C of the RAM 83. Every time when the switching switch 302A or 302B is operated, the CPU 81 obtains the positive result in Step S141 shown in FIG. 26, thereby receiving new bet information, and storing the received new bet information in the bet information storage area 83C of the RAM 83. In such a way, as shown in FIG. 24, in the bet information storage area 83C of the RAM 83, the plurality of bet information 411, 412, 413 . . . are stored in order of the inputs. The input orders are individually added to the respective pieces of bet information 411, 412, 413 . . . . Each piece of the bet information 411, 412, 413 . . . is a combination of the bet on the horse race game and the bet on the roulette game.

As described above, the CPU 81 accumulates such bet input results as the bet information in the bet information storage area 83C of the RAM 83 while executing the bet reception processing shown in FIG. 26 separately from the processing shown in FIG. 20.

Then, when both of the horse race game and the roulette game are ended, the CPU 81 executes the bet reception in the processing shown in FIG. 20. In the bet reception, the CPU 81 executes the processing shown in FIG. 25, thereby reading out the bet information accumulated in the RAM 83, and displaying the bet information on the image display device 88 (Step S106 or Step S110). In such a way, the CPU 81 gives the player the opportunity to change the bet information accumulated in the RAM 83.

Then, the bet information changed according to needs is transmitted to the control unit 13 in Step S109 shown in FIG. 20.

From the above, even in the case where either one of the bet screen for the horse race game and the bet screen for the roulette game is selected and displayed on the image display device 88 by the operation of the switching switch 302A or 302B, the player is always given the opportunity to input the bet regardless of the progress of the games.

Moreover, in the above-described embodiment, the description has been made of the case where the bet screen is displayed on the image display device 88, and the player operates the touch panel provided on the surface of the screen; however, the present invention is not limited to this. For example, a mechanical switch such as a button switch may be used. In the case of using the mechanical switch as the bet input button 401, a configuration can be adopted, in which a lamp is provided on a part or periphery of the switch, and the lamp is made to blink when there comes a state of receiving the bet.

Moreover, in the above-described embodiment, the description has been made of the case of progressing the games by using actual substances as the horse race gaming machine 11 that allows the model horses 55 to run, and as the roulette gaming machine 12 that launches the ball 78 onto the roulette wheel 71; however, the present invention is not limited to this. For example, there may be used gaming machines, on each of which the progress of the game is shown by a displayed image, such as gaming machines, in each of which an image of the game is displayed on a display screen of a liquid crystal display device or the like and the game is progressed by a motion of the image.

Moreover, in the above-described embodiment, the description has been made of the game apparatus including the horse race game and the roulette game; however, the present invention is not limited to this. The present invention can be applied to the case where the player participates in a plurality of other various games such as a card game. Furthermore, the number of games is not limited to two, and the present invention can also be applied to the case where the player participates in three or more games.

What is claimed is:

1. A game apparatus comprising:
a plurality of terminals, each of which receives a bet on a first game and a bet on a second game;
a bet control unit that allows a first betting period for receiving the bet on the first game and a second betting period for receiving the bet on the second game to overlap each other;
a first control unit that is provided commonly to the plurality of terminals and executes the first game; and
a second control unit that is provided commonly to the plurality of terminals and executes the second game.

2. The game apparatus according to claim 1, wherein each of the terminals visually displays elapse of time during the first betting period and the second betting period.

3. The game apparatus according to claim 1, wherein the bet control unit pre-stores the bet on the first game and the bet on the second game and receives the stored bets during the first and second betting periods.

4. A game apparatus comprising:
a plurality of terminals, each of which includes a first input unit that receives a bet on a first game, and a second input unit that receives a bet on a second game;
a bet control unit that allows a first betting period for receiving the bet on the first game and a second betting period for receiving the bet on the second game to overlap each other;
a first control unit that is provided commonly to the plurality of terminals and executes the first game; and
a second control unit that is provided commonly to the plurality of terminals and executes the second game.

5. The game apparatus according to claim 4, wherein each of the terminals visually displays elapse of time during the first betting period and the second betting period.

6. The game apparatus according to claim 4, wherein the bet control unit pre-stores the bet on the first game and the bet on the second game and receives the stored bets during the first and second betting periods.

7. A game apparatus comprising:
a plurality of terminals, each of which includes an input unit that receives a bet on a first game and a bet on a second game;
a switching control unit that allows the input unit to receive an input of the bet on the first game or to receive an input of the bet on the second game;
a bet control unit that allows a first betting period for receiving the bet on the first game and a second betting period for receiving the bet on the second game to overlap each other;
a first control unit that is provided commonly to the plurality of terminals and executes the first game; and
a second control unit that is provided commonly to the plurality of terminals and executes the second game.

8. The game apparatus according to claim 7, wherein each of the terminals visually displays elapse of time during the first betting period and the second betting period.

9. The game apparatus according to claim 7, wherein the bet control unit pre-stores the bet on the first game and the bet on the second game and receives the stored bets during the first and second betting periods.
